(19) United States
(12) Patent Application Publication
(10) Pub. No.: US 2026/0307033 A1
(43) Pub. Date: Oct. 8, 2026

(54) ELECTRIC RADIANT HEATING FOR DIRECT CONVERSION SYNGAS REACTOR

(71) Applicant: Aether Fuels Pte Ltd., Singapore (SG)

(72) Inventors: Sanjiv Dabee, Aliso Viejo, CA (US); Scott Tatro, Chicago, IL (US); Malou Camara, Bridgewater, NJ (US); Craig Tiras, Galveston, TX (US); Ramakrishnan N. Tirunellai, Navi Mumbai (IN)

(73) Assignee: Aether Fuels Pte Ltd., Singapore (SG)

(21) Appl. No.: 19/633,715

(22) Filed: Mar. 30, 2026

Related U.S. Application Data
(60) Provisional application No. 63/783,810, filed on Apr. 4, 2025.
(60) Provisional application No. 63/903,594, filed on Oct. 22, 2025.

(51) Int. Cl. B01J 8/06; C01B 3/384

(52) U.S. Cl. CPC B01J 8/067; B01J 8/065; C01B 3/384; B01J 2208/00407; B01J 2208/00415; B01J 2208/00893; B01J 2208/065; C01B 2203/0227; C01B 2203/085

(57) ABSTRACT

Reactor configurations for direct conversion syngas reactors are described herein. The reactors herein have a plurality of tubes in parallel arrangement within a housing, each tube containing a catalyst; and a plurality of electrical radiant heaters arranged in proximity with the plurality of tubes, wherein the electrical radiant heaters extend along a longitudinal direction of the plurality of tubes, are distributed along a longitudinal direction of the plurality of tubes, or both.

### CROSS-REFERENCE TO RELATED APPLICATIONS

This application for patent claim priority benefit of U.S. Provisional Patent Application Ser. No. 63/783,810, filed Apr. 4, 2025, and of U.S. Provisional Patent Application Ser. No. 63/903,594, filed Oct. 22, 2025, each of which is entirely incorporated herein by reference.

### BACKGROUND

Processes to make synthesis gas (“syngas”) are becoming more necessary as the need for renewable materials manufacturing grows. Catalysts are typically used to make syngas from materials such as methane and carbon dioxide. These catalysts are useful for performing reforming reactions that convert methane, with steam, carbon dioxide, or both, to a mixture of carbon monoxide and hydrogen. These catalysts also convert mixtures of carbon dioxide and hydrogen to carbon monoxide and water. Each of these reactions is highly endothermic, requiring substantial thermal energy input to occur.

Conventional methods of providing heat for such reactions have primarily relied on fuel combustion. Such methods, including for example gas fired heating, add carbon dioxide and nitrogen dioxide to the atmosphere and waste thermal energy. Such heating methods are also difficult to control, leading to uneven heating and thermal dispersion. Where catalyst is arranged in multiple reaction tubes for scale and uniform contact with gas flow, controlling heat input to the various tubes of catalyst using a gas fired arrangement is quite challenging, in addition to being environmentally burdensome. Some catalyst may be overheated while other catalyst is insufficiently heated.

Such prior methods of heating reforming reactors frequently result in hot spots, poor thermal control, and poor operational feedback. There is need for efficient, effective, and environmentally responsible heating for reactors that make syngas.

### SUMMARY

Embodiments described herein provide a syngas manufacturing reactor that has a plurality of tubes in parallel arrangement within a housing, each tube containing a catalyst; and a plurality of electrical radiant heaters arranged in proximity with the plurality of tubes, wherein the electrical radiant heaters extend along a longitudinal direction of the plurality of tubes, are distributed along a longitudinal direction of the plurality of tubes, or both.

Other embodiments described herein provide a syngas manufacturing reactor that has a plurality of tubes in parallel arrangement within a housing, each tube containing a direct conversion syngas catalyst; and a plurality of electrical radiant heaters arranged in proximity with the plurality of tubes, wherein the electrical radiant heaters extend along a longitudinal direction of the plurality of tubes, are distributed along a longitudinal direction of the plurality of tubes, or both.

Other embodiments described herein provide a syngas manufacturing reactor that has a plurality of tubes in parallel arrangement, each tube containing a catalyst in a catalyst containing portion thereof; and an electrical radiant heating structure arranged in proximity with the plurality of tubes, wherein the electrical radiant heating structure extends along a longitudinal direction of the plurality of tubes, transverse to the longitudinal direction of the plurality of tubes, or both, to enclose the catalyst containing portion of each tube, and the electrical radiant heating structure comprises a plurality of movable heating structure members, each heating structure member having a plurality of terminal members attached to the heating structure member to provide electric power.

Other embodiments described herein provide a method of making syngas that includes flowing a feed gas through a plurality of tubes arranged in substantially parallel orientation and containing a direct conversion syngas catalyst; enclosing the plurality of tubes in an electrical radiant heating structure comprising a plurality of heating structure members, each comprising a movable support, to provide radiant heat to the tubes, wherein the electrical radiant heating structure extends along a longitudinal direction of the tubes, is distributed along the longitudinal direction of the tubes, or both; reacting the feed gas within the tubes to form syngas; and moving at least one of the heating structure members away from the tubes, using the movable support thereof, to provide access to the tubes and portions of the heating structure member.

### BRIEF DESCRIPTION OF THE DRAWINGS

FIG. 1A is a schematic cross-sectional view of a reactor according to one embodiment.

FIG. 1B is a schematic top view of the reactor of FIG. 1A.

FIG. 1C is a schematic top view of a reactor according to another embodiment.

FIGS. 1D-1F show reaction tubes that have process enhancement according to embodiments herein.

FIG. 2A is a schematic cross-sectional view of a reactor according to another embodiment.

FIG. 2B is a top view of the reactor of FIG. 2A.

FIG. 2C is a top view of a reactor according to another embodiment.

FIG. 3A is a schematic cross-sectional view of a reactor according to another embodiment.

FIG. 3B is a schematic top view of the reactor of FIG. 3A.

FIG. 4A is a schematic top view of a reactor facility according to another embodiment.

FIG. 4B is a schematic partial cross-section side view of the reactor facility of FIG. 4A.

FIG. 4C is a schematic side view of the reactor facility of FIG. 4A in a different operative state.

FIG. 4D is a schematic side view of the reactor facility of FIG. 4A in a different operative state.

FIG. 5A is a schematic top view of a reactor according to another embodiment.

FIG. 5B is an exploded top view of the reactor of FIG. 5A.

FIG. 5C is a schematic elevation view of a panel of the reactor of FIG. 5A.

FIG. 5D is an isometric view of a heating member structure according to one embodiment

FIG. 6 is a schematic side view of a reactor facility according to another embodiment.

FIG. 7A is a schematic top view of a reactor facility according to another embodiment.

FIG. 7B is a schematic side view of the reactor facility of FIG. 7A.

FIG. 8A is a schematic top view of a reactor facility according to another embodiment.

FIG. 8B is a schematic side view of the reactor facility of FIG. 8A.

FIG. 9A is a schematic top view of a reactor facility according to another embodiment.

FIG. 9B is a schematic top view of a reactor facility according to another embodiment.

FIG. 9C is a schematic top view of a reactor facility according to another embodiment.

### DETAILED DESCRIPTION

Reactor configurations are described herein for making synthesis gas (“syngas”) from carbon-containing gases using electric radiant heating to provide thermal energy for the reactions. Electrically driven radiant heat members are disposed in various configurations to heat reactor internal structures using radiant energy. The heated structures, in turn, heat catalyst to drive direct conversion of the carbon-containing gases into a desired mixture of carbon monoxide and hydrogen.

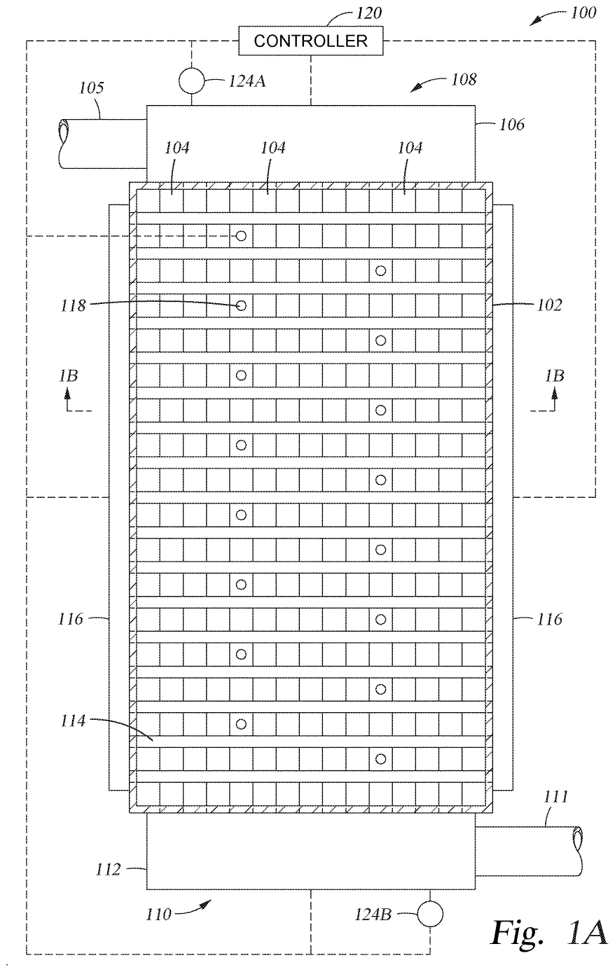

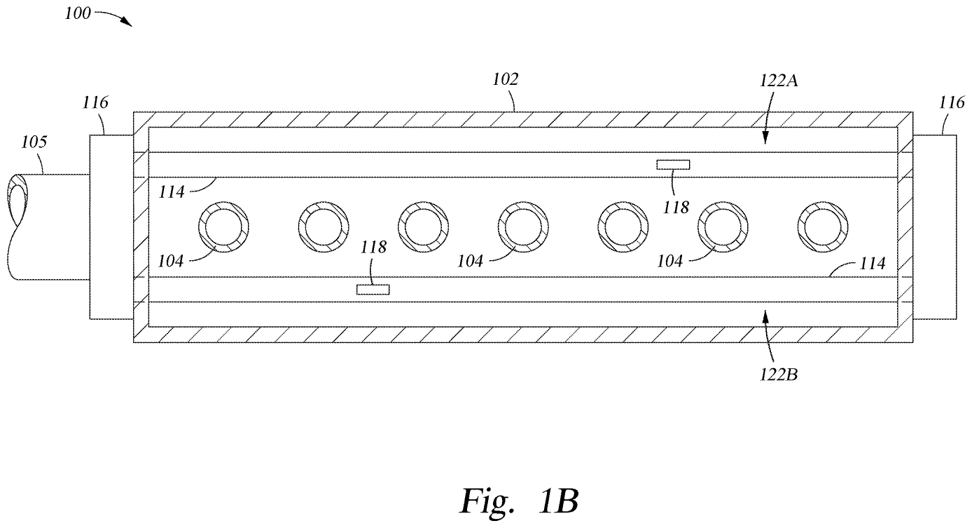

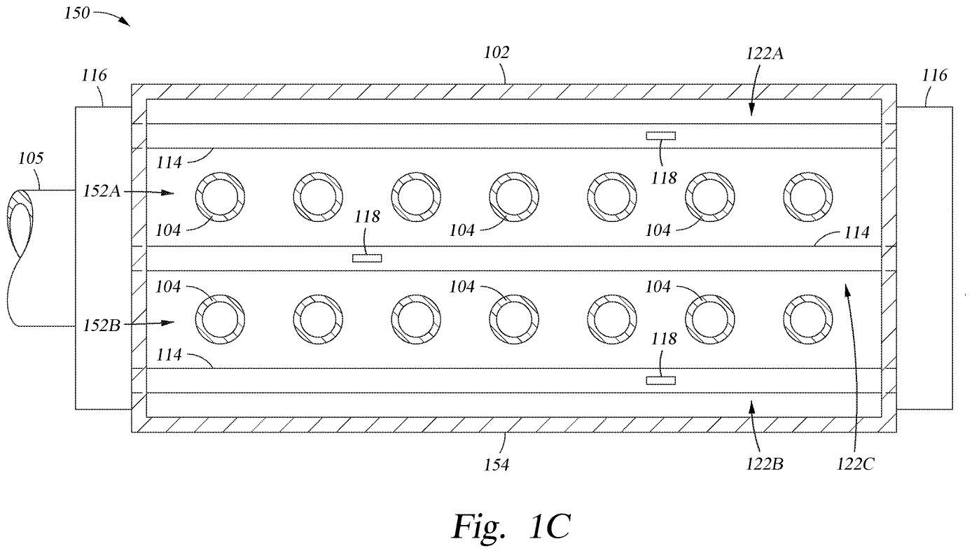

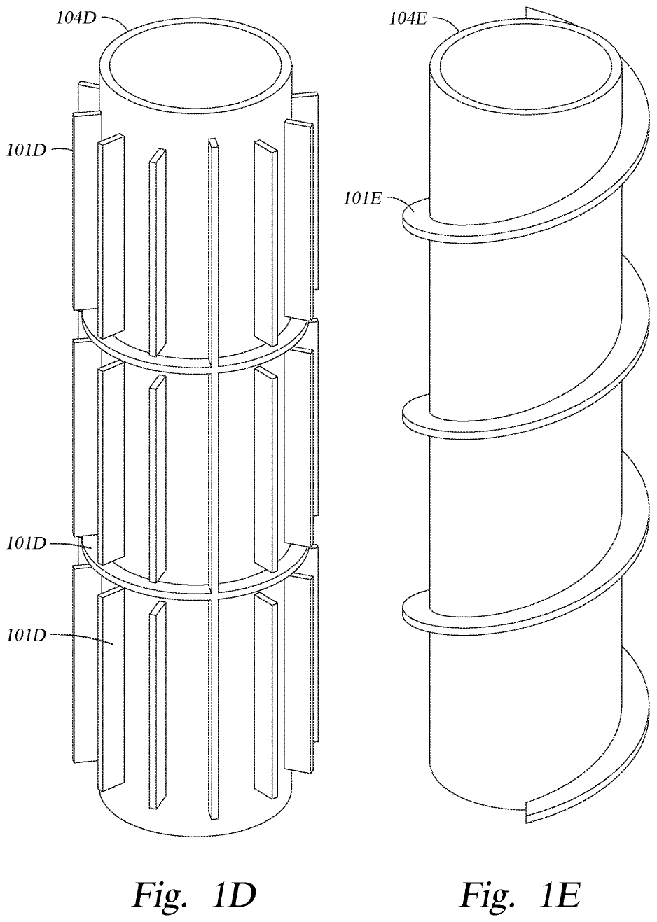

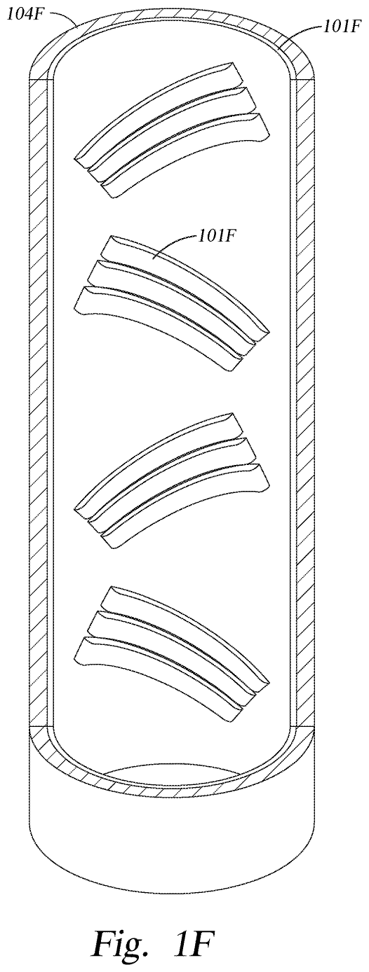

FIG. 1A is a schematic cross-sectional view of a reactor 100 according to one embodiment. The reactor 100 uses radiant heating to heat tubes filled with catalyst to drive a reaction, within the tubes, that converts carbon-containing molecules such as methane, other light hydrocarbons, and carbon dioxide, optionally along with water (steam) and/or hydrogen, into a mixture of carbon monoxide and hydrogen. Conversion of various species can be controlled by adjusting temperature and pressure within the tubes.

One direct conversion syngas reactor is a Tri-Converter™ reactor available from Aether Fuels of Chicago, Illinois. A Tri-Converter reactor is a direct conversion syngas reactor that can stably directly convert methane, carbon dioxide, and optionally other hydrocarbons into syngas (a mixture of carbon monoxide, CO, and hydrogen gas, H₂) via steam reforming, the conversion of CH₄ and steam (i.e. water) into CO and H₂, and dry reforming, the conversion of CH₄ and CO₂ into CO and H₂ with controllable composition that can be optimized for downstream reactions. The reactor is a Tri-Converter reactor because under many conditions a third reaction, the Water Gas Shift-Reverse Water Gas Shift will occur. The syngas produced by a direct conversion syngas reactor, from an appropriate feed stream, has an attractive ratio of H₂ to CO, usually between about 1.5 and 2.5 depending on different processes, for chemical product manufacture using Fischer-Tropsch methods. This ratio can be tuned by adjusting the input feed composition (e.g. the stream composition relative to the other components) and by adjusting the temperature and pressure (which shift the thermodynamic equilibrium of the various reactions).

The direct conversion syngas reactor comprises one or more vessels. These may be elongated pressure vessels such as drums or tubes, or any suitable vessel configuration. A vessel of this type contains a catalyst, which may be formed in a catalyst bed, or coated or adhered onto, or embedded with, a structure of the vessel in a way that provides exposure of the catalyst to reactant fluids. The reactor also comprises a heat delivery system that delivers heat into the reactor to head the reaction space containing the catalyst to drive the reactions, which are generally endothermic, and any additional heat needed to ensure the reactant fluids are at the desired process temperature.

The catalyst in the direct conversion syngas reactors herein may comprise a single heterogeneous catalyst, e.g. a noble metal on an oxide support, or multiple catalysts, e.g. first catalyst comprising a noble metal on an oxide support and a second catalyst. The catalyst has stable activity for steam methane reforming, as CH₄+H₂O⇄CO+3H₂, and dry reforming, as CH₄+CO₂⇄2CO+2H₂.

Conventionally catalysts that have good activity for steam methane reforming do not have good stability for dry reforming, and thus conventionally the feed and process conditions are selected to suppress dry reforming (e.g. by minimizing CO₂ in the feed and/or by utilizing high amounts of steam so that the steam reforming reaction dominates) but such methods may form syngas that is suboptimal for downstream chemical product manufacture, having a ratio of H₂ to CO that is typically above 2.5, where the preferred ratio for chemical product manufacture is between 1.5 and 2.5. Such methods can also be suboptimal where it is desired to use CO₂ as part of the input stream and convert it into syngas.

In addition to methane, CO₂, and steam, one can also provide H₂ as an input to the direct conversion syngas reactor. As noted above, the Water Gas Shift-Reverse Water Gas Shift reaction, as CO+H₂O⇄CO₂+H₂, can occur, and one can introduce H₂ as an input to shift the thermodynamic equilibrium of the reaction. In one embodiment of a process using a direct conversion syngas reactor, it is even possible to supply only CO₂ and H₂ as input and use the reactor as a reverse water gas shift reactor to convert CO₂ into CO. Thus, a single catalyst can be a tri-conversion reforming catalyst that has stable activity for steam methane reforming, dry reforming, and the Water Gas Shift—Reverse Water Gas Shift reactions.

The catalyst is configured to balance contact surface area, heat input, and pressure drop for optimal performance. Generally, the catalyst is rendered into a shaped pellet, grain, or piece having an outer surface with very high surface area, onto which a noble metal material is deposited. Any suitable catalyst shape can be used.

In one case, cylindrical or quasi-cylindrical catalyst pellets with longitudinal through-holes are used. The pellets can have circular outer circumference or a quasi-circular outer circumference having symmetrical radial dips in a radial inward direction of the catalyst pellet.

Each catalyst pellet has a ratio of surface area to volume that is about 0.8 to about 2.0, such as about 1.0 to about 1.8, for example 1.3 or 1.4. A catalyst pellet can have the shape of a right circular cylinder, with two opposite ends, a first end and a second end, each of which is circular. In another case, a catalyst pellet can have the shape of a right circular cylinder with radial dips in the radial inward direction of the catalyst pellet. Where a pellet has radial dips, the pellet can have any number of radial dips generally distributed around the pellet circumference in a uniform manner. The quasi-cylindrical pellet can thus have radial symmetry about a cylindrical axis similar to a right circular cylinder.

The through-holes are generally formed to extend through the pellet from the first end to the second end along a line that is parallel to the cylindrical axis of the pellet. In one case, each catalyst pellet has a first through-hole formed along the cylindrical axis of the pellet and a plurality of second through-holes formed around the first through-hole in a uniform distribution. In one case, there are nine of the second through-holes, so each catalyst pellet in this case has 10 through-holes. In such cases, the through-holes can all have the same diameter or different diameters in any arrangement. In the case where the catalyst pellet has a first central through-hole and a plurality of second peripheral through-holes, the first through-hole can have a diameter that is from about 10% to about 30% of the diameter of the catalyst pellet, such as from about 15% to about 25%, for example about 20% of the diameter of the catalyst pellet. Also, in such cases, each of the second through-holes can have a diameter larger or smaller than the diameter of the first through-hole. In one case, each of the second through-holes has a diameter that is about 80% of the diameter of the first through-hole.

In one case, a catalyst pellet has a plurality of peripheral through-holes of the same size uniformly distributed along the periphery of the catalyst pellet, in a circumferential direction, about a larger center through-hole, and a circumference with a plurality of radial dips uniformly distributed along the circumference of the pellet. The pellet can have a radial dip equidistantly spaced between each pair of adjacent peripheral through-holes. In one case, the radial dip can have a depth and curvature selected to provide a circumferential segment, adjacent to each peripheral through-hole, that has a center of curvature at a center of the adjacent peripheral through-hole. Such pellets can be referred to as having a “floral” shape.

The catalyst pellets can be sized according to any specification. The size of the catalyst pellets, in relation to the size of the tubes into which the catalyst pellets are to be loaded, can be selected to provide a desired bulk surface area and a desired pressure drop in trade-off relationship. In this case, a ratio of the catalyst pellet diameter to the tube diameter is from about 0.1 to about 0.3, such as from about 0.15 to about 0.25, for example about 0.2. A ratio of the catalyst pellet length to the tube diameter can be the same as, or different from, the ratio of the catalyst pellet diameter to the tube diameter. Thus, the catalyst pellet can have a length that is the same as its diameter, or the catalyst pellet can be longer or shorter than its diameter.

Conventionally, heat delivery for a direct conversion syngas reactor utilizes combustion based heating, referred to frequently as “firing” so that such reactors are sometimes called “fired reactors.” In such cases, a fuel is supplied to the heating system and is combusted to produce heat, for example in the resulting flue gas, which is then flowed through the chamber to heat the catalyst. Where the catalyst is housed in an internal structure such as tubes, the flue gas is thermally contacted with the tubes to transfer thermal energy through the catalyst tube walls into the catalyst and the reaction space. In the reactors herein, the heat delivery system utilizes radiant heaters to deliver radiant heat to the tubes. The radiant heat adds thermal energy to the material of the tubes, which is then transferred into the catalyst within the tubes by convection and conduction at interior surfaces of the tubes. The heat delivery system may have multiple sections, wherein different thermal fluxes can be delivered to the catalyst in each section to control the temperature of the catalyst in each section more precisely. As noted above, the direct conversion syngas reactor can be controlled, and provided with a blend of feedstocks, to yield syngas having a favorable and controllable molar ratio of H₂ to CO for chemical product manufacture, which is typically a ratio of about 1.5 to 2.5.

The reactor 100 has a housing 102 that houses a plurality of tubes 104, each of which contains a catalyst. The reactor 100 may be a direct conversion syngas reactor, as described above, so the tubes may contain catalyst to accomplish the reactions above. The tubes 104 are generally oriented along a longitudinal direction of the housing 102. A feed distributor 106 is coupled to a first end 108 of the housing 102 to route feed gas into the tubes 104 substantially uniformly. One or more feed gas conduits (not shown) would be coupled to the feed distributor 106 in any suitable way to provide feed gas to the reactor 100. The feed gas flows through the tubes 104 from the first end 108 to a second end 110 of the housing 102, reacting while travelling through the catalyst within the tubes 104. A product gas exits the tubes 104 at the second end 110. A product plenum 112 is coupled to the second end 110 of the housing 102 to recover the product gas from the reactor 100. One or more product gas conduits (not shown) would be coupled to the product plenum 112 to withdraw the product gas from the product plenum 112. The tubes 104 are vessels to hold catalyst within the reactor 100 so that the above reactions can be performed therein. It should be noted that vessels other than tubes can be used in the reactors herein, as suited to the needs of particular processes.

A plurality of radiant heat members 114 are disposed within the housing 102 in proximity with, substantially adjacent to, the tubes 104. The radiant heat members 114 are spaced apart from the tubes 104 to allow radiant heat from the radiant heat member 114 to heat the tubes 104. Each radiant heat member 114 is a tubular or rod-like member that comprises a radiator, and the radiant heat members 114 are driven to emit radiant energy by flowing electric current through each member 114. Each radiant heat member 114 extends in a direction transverse to the orientation direction of the tubes 104, and are distributed substantially uniformly along longitudinal direction of the tubes 104. Spacing of the radiant heat members 114 in the longitudinal direction of the housing 102 can be selected to provide a desired heating profile along the tubes 104. Electrical couplings 116 are electrically coupled to the radiant heat members 114 to provide electrical power. Flow of electricity through the radiant heat members 114 causes ohmic heating of the radiant heat members 114, which as a result emit radiation to heat the tubes 104. The electrical couplings 116 can comprise one or more controllers to control the flow of electricity to the members 114 so that the heat delivery of each of the members 114 can be individually controlled, collectively controlled, or controlled in groups. The electrical couplings 116 include, or are electrically coupled to, a power source (not shown) to provide the electricity.

The radiant heat members 114 are generally of a type capable of heating the tubes 104 to temperatures necessary to drive the chemical reactions within the tubes 104. In the case of the reactions described above to make syngas, the radiant heaters have solid components that rise in temperature when an electric current passes through them due to ohmic heating. In many cases the components are a metal alloy such as Ni—Cr or Fe—Cr, or a non-metal material such as silicon carbide. The heaters may have, or may contain, fibers, blocks, bricks or other shapes of radiators, and any suitable configuration of radiators may be used. Each radiant heat member 114 has a radiator that emits heating radiation, and may also have a thermal generator, such as a wire or other conductor, disposed within the radiator. For example, a silicon carbide fiber or rod, or ceramic fiber radiator may have a conductive wire disposed within that generates the thermal energy to heat the radiator. A silicon carbide fiber or rod can also conduct electricity sufficiently to radiate thermal energy without an added conductor.

One or more thermal sensors 118 can be used in the reactor 100. The thermal sensors 118 can be located at any useful location. Here, a plurality of thermal sensors 118 are coupled with the radiant heat members 114 to measure a temperature in the reactor 100. The thermal sensors 118 can be, for example, in proximity with the radiant heat members 114, but not in direct contact with the radiant heat members 114 where extreme temperatures may be encountered. The thermal sensors 118 are here arranged in a uniform pattern among the radiant heat members 114, where a first thermal sensor 118 is aligned with a second thermal sensor 118 along a longitudinal direction of the reactor 100, a third thermal sensor 118 is aligned with a fourth thermal sensor 118, the third thermal sensor 118 is not aligned with either the first or the second thermal sensor 118, and the fourth thermal sensor 118 is not aligned with either the first or the second thermal sensor 118. The thermal sensors 118 are here arranged in an alternating pattern, symmetrically disposed on either side of a central longitudinal axis of the housing 102. In other embodiments, one column of thermal sensors 118 can be interdisposed with the radiant heat members 114, for example along the longitudinal direction of the reactor 100.

Shown here, the thermal sensors 118 can be located between two neighboring heat members 114, approximately equidistant from the two neighboring heat members 114, but the thermal sensors 118 can be arranged in any convenient and useful manner. Thermal sensors can also be located adjacent to the reactor 100 in a process using the reactor 100. For example, one or more thermal sensors can be coupled to piping downstream of the reactor 100. The thermal sensors 118 are shown here spaced apart from the radiating surfaces of the heat members 114, approximately equally distant from two neighboring heat members 114, but in some cases the thermal sensors 118 can also be disposed in direct physical contact with the radiating surface of a heat member 114. Alternately, or additionally, some or all of the thermal sensors 118 can be coupled with tubes 104 of the reactor 100, and some tubes can have more than one thermal sensor coupled thereto.

The thermal sensors 118 sense the thermal condition within the reactor 100. A controller 120 can be operationally coupled to the thermal sensors 118 to receive signals from the thermal sensors 118 that represent the temperature, or other thermal condition such as thermal flux, at the emission surface of the heat member 114 sensed by the sensor 118. Here, the controller 120 is shown with operational coupling to one of the sensors 118 to simplify the figure, but the controller 120 can have operational couplings to all the sensors 118 shown in the figure. The controller 120 can be configured to determine a temperature at or near the location of the thermal sensor 118, for example the temperature of the emission surface of the respective radiant heat member 114 near the sensor 118 or even within the catalyst inside the tubes 104, and can be operationally coupled to one or both electrical couplings 116 and/or the power supply (not shown) to control power to the radiant heat members 114 to target a thermal condition within the reactor 100. The target condition can be the same for all the sensors 118 or can be different in any pattern, direction, or manner. For example, targets can be assigned to the thermal sensors 118 to result in a temperature gradient within the tubes 104, which can be any kind of gradient. For example, a center-edge temperature gradient can be programmed, which can be uniform or non-uniform along the length of the reactor 100. Alternately, a temperature gradient along the length of the reactor 100 can be programmed. The controller 120 can also be operatively coupled to the feed distributor 106, the product plenum 112, the feed conduit (not shown), and/or the product conduit (not shown), and/or to flow controllers coupled to these components, to control flow of gases into and out of the reactor 100 based on the signals from the thermal sensors 118. If a signal from a thermal sensor 118 indicates the thermal condition at that sensor 118 is below a target, flow of electricity can be increased to the radiant heat member 114 sensed by the sensor 118, flow of gas to the feed distributor 106, or from the feed distributor 106 into the tubes 104, can be reduced, flow of product gas from the product plenum 112 can be reduced, or any combination thereof. Likewise, if a signal from a thermal sensor 118 indicates the thermal condition at that sensor 118 is above a target, flow of electricity can be decreased to the radiant heat member 114 sensed by the sensor 118, flow of gas to the feed distributor 106, or from the feed distributor 106 into the tubes 104, can be increased, flow of product gas from the product plenum 112 can be increased, or any combination thereof. The thermal condition at the radiating surface of the radiant heat member 114 varies with temperature within the catalyst where the reaction occurs, so the thermal condition at the radiation emitting surface of the radiant heat members 114 is a good indicator of thermal condition within the catalyst. Thus, temperature probes within the catalyst, as is typically used with conventional heating means, are not needed.

A thermal sensor can also be disposed within one or more of the tubes 104 to sense thermal condition within the tube 104 directly. One or more such sensors can be used, and sensors can be disposed at different locations with the tubes or within a single tube 104. Any suitable type of thermal sensor, such as those described elsewhere herein, can be used. In some cases, a multipoint thermocouple can be disposed within a tube to provide signals representing thermal condition within the catalyst at different locations.

Gas analyzers can be used to monitor composition of feed gas provided to the reactor 100 and product gas obtained from the reactor 100. A first gas analyzer 124A is coupled to the feed distributor 106 to monitor composition of the gas in the feed distributor 106 to be contacted with the catalyst inside the tubes 104. A second gas analyzer 124B is coupled to the product plenum 112 to monitor composition of the gas exiting the tubes 104. These gas analyzers are optional. Where needed, the gas analyzers 124 may utilize coolers to prepare samples for analysis by setting a temperature of the gas to a suitable temperature for analysis.

The controller 120 can be operatively coupled to the gas analyzers 124A and 124B to receive signals from the gas analyzers 124A and 124B representing composition of the gases in the feed distributor 106 and the product plenum 112 respectively. The controller 120 can be configured to infer composition from the signals and to control temperature at any zone of the reactor 100, based on the signals and/or the inferred compositions, by adjusting electric current flow to one or more of the radiant heat members 114. The controller 120 can also be configured to adjust a pressure in the feed distributor 106, the product plenum 112, or both, based on the signals, the inferred compositions, and/or any signal from one or more thermal sensors, or any parameter inferred from such signals. The controller 120 can also be configured to adjust a flow rate of gas through the feed distributor 106, the product plenum 112, or both, based on the signals and/or the inferred compositions, and/or any signal from one or more thermal sensors, or any parameter inferred from such signals. The controller 120 can also be configured to infer, from the signals of the gas analyzers 124A and 124B, the presence of any impurities in the feed gas or the product gas. Impurities such as sulfur containing compounds that might appear in a source of methane or carbon dioxide, and that might damage the catalysts inside the tubes 104, can be detected using the first gas analyzer 124A. Impurities in the catalyst materials that might volatilize from the high temperatures achieved by the reactor 100 can be detected by the second gas analyzer 124B. The first and second gas analyzers 124A and 124B can be calibrated to detect any impurities at concentration levels that might be in, or come from, any source of material to be provided to the reactor 100.

The tubes 104 can have process enhancement, which can be surface area enhancements, flow turbulence enhancements, heat transfer enhancements, or any combination thereof. Such enhancements can be at, or on, the interior surface and/or the exterior surface of each tube 104. Surface area enhancements can be enhancements to the radiation absorbing surface, the radiating emitting or transferring surface, or both. Heat transfer enhancements can be enhancements at the surface of a tube 104, enhancements in the interior of the tube 104, or both. Flow turbulence enhancements are structures of the tubes 104 that contact gas flowing within the tube to disrupt the boundary layer that forms at the tube inner wall.

FIG. 1D shows a tube 104D with exterior process enhancements 101D. FIG. 1E shows a tube 104E with another exterior process enhancement 101E. FIG. 1F shows a cross-section of a tube 104F with interior process enhancements 101F.

Surface area enhancements can be any structure along the tube inner or outer wall that increases the surface area of the wall that can be used for absorption of thermal energy and/or emission of thermal energy. Surface area enhancements at the inner and/or outer walls of the tubes 104 increase heat flux into the interior of the tubes 104. The surface area enhancements can be, or can include, fins, vanes, bumps, grooves, fingers, ridges, and other structures that extend away from the interior and/or exterior surface of the tubes 104 in any manner and to any extent.

Flow turbulence enhancements are generally formed along the inner wall of the tubes 104 as bumps, dimples, discontinuities, or other structures that disrupt laminar gas flow along the inner wall of the tubes 104. Such enhancements can extend radially inward from the inner wall, or radially outward where the enhancements are depressions, recesses, or gaps along the inner wall of the tube. The flow turbulence enhancements reduce a thickness of a boundary layer of gas along the inner wall of the tubes as gas flows within the tubes. The reduced boundary layer thickness enhances thermal transport across the boundary layer from the tube inner wall to the interior volume of the tubes 104. In one embodiment, one or more of the tubes 104 can have an inner wall with random scratching, scoring, or grooving, which can be formed by applying a grooving tool, like stiff wire brush, to the inner wall of the tube 104 in a random manner. In another embodiment, one or more of the tubes 104 can have an inner wall with patterned scoring.

Heat transfer enhancements to the tubes 104 generally reduce resistance to heat transfer into the tube wall and/or out of the tube wall by configuring the tube wall and/or the tube bulk material, to readily absorb radiant energy as thermal energy at the tube outer wall and/or emit or otherwise transfer thermal energy from the tube inner wall into the tube interior. A heat transfer enhancement can be a coating that is applied to the inner wall and/or outer wall of the tube or a material selection for the tube that enhances heat transfer to the tube interior. In one case, a high emissivity coating can be applied to the inner tube wall to enhance transfer of thermal energy from the material of the tube to the interior of the tube. In another case, the tube can be made of a material that provides heat transfer that is greater than a conventional metal tube. For example, the tube can be made of, or made substantially of, a material such as quartz that is mostly transmissive to thermal radiation, such that radiant heat passes through the tube and directly heats the contents, such as catalyst and gases, within the tube.

The process enhancements of the tubes can be made of the same material as the rest of the tube, or can be different materials. One tube can have a first set of process enhancements that are made of the same material as the tube and a second set of process enhancements that are made of a material different from the material of the tube. In some cases, the tube can be formed with the process enhancements as an integral part of the tube such that the surface enhancements are integral to the tube. Thus, where the tube is to have structures along the inner or outer wall, the tube can be cast or molded to have such structures. Alternately or additionally, process enhancements can be applied to a tube such that the process enhancement is not formed as an integral part of the tube but is attached to the tube afterward. The process enhancements can be made of materials that are different from the material of the tube, particularly where the process enhancement is intended to change a material property of the tube.

In some cases, the process enhancement can be a surface treatment of the inner wall and/or the outer wall of the tube 104 to change a property of the surface such as roughness, chemical affinity, thermal properties, or combination thereof. Thus, for example, a surface treatment can be applied to the inner wall of the tube, the outer wall of the tube, or both, that increases roughness of the tube surface. In such cases, increasing surface roughness can add surface area for thermal absorption, emission, and/or transmission. Increasing surface roughness along the inner tube wall can also increase boundary turbulence of the flowing gas. In some cases, the inner wall of each tube can be treated to have different surface roughness in different areas such that gas flowing along the inner wall of the tube encounters turbulence enhancing structures at different parts of the tube. Such surface roughness can be configured in patterns, which can be gradient patterns, repeating patterns, or other patterns.

One or more fins can be provided on the outer wall of each of, or some of, the tubes 104. Such fins can be continuous, discontinuous, or both, and can extend in a longitudinal direction of the tube, in an azimuthal direction of the tube, or any combination thereof. Helical fins can be used. Mixtures of tubes extending in such directions can be used. For example, fins that extend vertically along the outer wall of the tube can be intermixed and/or interspersed with fins that extend azimuthally around the circumference of the outer wall of the tube. Specifically, along the length of a tube, one section can have one or more azimuthal fins while an adjacent section has one or more longitudinal fins in an alternating relationship. Fins can have any length, width, or spacing, which can be uniform, non-uniform, patterned, varying, or any combination thereof. Thus, segmented fins can extend from the outer wall of the tube, along the length thereof, around the circumference thereof, or any combination thereof. Such segmented fins can have any length, and any distribution of lengths, and can be arranged uniformly or non-uniformly along the tube outer wall.

In one embodiment, a plurality of fins extends radially outward from the outer wall of each tube 104. These fins extend linearly in the longitudinal direction of the tube 104 from one end, or a location near one end, to the opposite end, or a location near to the opposite end, of the tube. These fins are uniformly spaced, in the azimuthal direction of the tube, around the outer circumference of the tube. These fins extend away from the outer wall of the tube a distance that is about equal to the radius of the tube. These fins have a thickness that is about half the thickness of the tube wall, from the inner wall to the outer wall of the tube 104.

In another embodiment, one or more fins extend in a helical manner around the circumference of the tube and in the longitudinal direction of the tube. These fins can extend in a right-handed helical manner, a left-handed helical manner, or both. These fins can have thickness and width (distance the fin extends from the outer wall of the tube) that is uniform, non-uniform, patterned, or varying in any suitable manner. These fins can be continuous along the length of the tube or discontinuous. Thus, segmented helical fins can extend from the outer wall of the tube, in the azimuthal direction and the longitudinal direction of the tube. Such segmented fins can have any length, and any distribution of lengths, and can be arranged uniformly or non-uniformly along the tube outer wall.

Fins can be any cross-sectional shape. Fins can have a rectangular, square, triangular, or in general any polygonal cross-section. Fins can also have an angular or curved cross-section. Thus, fins can have a round, or rounded cross-sectional shape, which may be circular, elliptical, oval, or stadium shape.

FIG. 1B is a schematic top view of the reactor 100. The feed distributor 106 is removed in this view to show the internal structure and arrangement of components of the reactor 100. As can be seen in FIG. 1B, there are two panels 122 of radiant heat members 114. A first panel 122A of the radiant heat members 114 is visible in FIG. 1A, and both panels, the first panel 122A and a second panel 122B located opposite the tubes 104 from the first panel 122A, are visible in FIG. 1B. Each panel 122 of radiant heat members 114 comprises a plurality of the radiant heat members 114 arranged in parallel relationship, so the radiant heat member 114 of a panel 122 are effectively in a coplanar arrangement. The two panels 122 of radiant heat members 114 are arranged on opposite sides of the tubes 104 in this case, and are equidistant from the tubes 104 to provide uniform heating, for example to maintain a uniform temperature among and along the tubes 104, if desired and achieved by operation of the controller 120. The radiant heat members 114 arranged as in FIG. 1B can be operated to provide a temperature gradient in a radial direction in each of the tubes 104. In such cases, if desired, the radiant heat members 114 can be operated to vary the radial direction temperature gradient within the tubes 104 as a function of location along the length of the tubes 104.

In other cases, thermal sensors can be disposed in contact with an outer surface of the tubes 104, in contact with an inner surface of the tubes 104, within the catalyst inside the tubes 104 and not in contact with the tubes, and/or outside the tubes 104 and not in contact with any radiant heat member 114. Any combination of arrangements can also be used. The sensors can be any type, or combination of types, of thermal sensors. For example, thermal sensors can be capacitive devices, piezoelectric devices, radiation sensing devices, resistive devices, pressure devices, or any combination thereof.

The arrangement of FIG. 1B shows one grouping of tubes 104 disposed within the housing 102 in a substantially coplanar arrangement with two groupings or panels 122 of radiant heat members 114, the radiant heat members of each panel 122 in substantially coplanar arrangement, the panels 122 equidistant from the tubes 104. Each of the panels is a grouping of the radiant heat members 114 arranged in the same way, in a parallel arrangement with uniform spacing that is the same between the two panels. In this way, the tubes 104 are subjected to radiant heat that has the same pattern along the length of each of the tubes 104. The space between the tubes 104 and the radiant heat members 114 can be selected according to the needs of any process, and can be the same for all or can vary according to any pattern or even randomly, if such variation is desired. The space may be selected to optimize incidence of radiant energy on the tubes 104 and transport of thermal energy into the tubes 104. The radiant heat members 114 can have thermal sensors 118 as in FIG. 1A or according to any pattern among the radiant heat members 114.

FIG. 1C is a schematic top view of a reactor 150, according to another embodiment. The reactor 150 is similar to the reactor 100, but with two ranks 152 of tubes 104, a first rank 152A and a second rank 152B, where the reactor 100 has only one rank of tubes 140. Thus, tubes 104 can be arranged in one or more ranks, and in some cases more than two ranks. Any reasonable number of ranks of tubes 104 can be arranged in the housing 102. The tubes 104 of each rank 152 are, in this case, arranged in coplanar parallel arrangement to extend along the longitudinal direction of the housing 102, so each rank has tubes 104 arranged along a single plane, and the ranks 152 of tubes 104 are arranged so that the tubes 104 of one rank 152 are aligned in rectilinear fashion with the tubes 104 of the other rank 152, forming a bundle arrangement of the tubes 104. There are three panels 122 of radiant heat members 114 in FIG. 1C, the first and second panels 122A and 122B along with a third panel 122C, each panel 122 substantially similar to, or the same as, the panels of radiant heat members 114 of the reactor 100. In this case, one panel 122 of radiant heat member 114 is disposed between the two ranks 152 of tubes 104 of the reactor 150, spaced approximately equally between the two ranks of tubes 104. The first panel 122A of heat members 114 is located along the first rank 152A of tubes 104 with the first rank 152A of tubes 104 between the first panel 122A and the third panel 122C of heat members 114. The second panel 122B of heat members 114 is located along the second rank 152B of tubes 104 with the second rank 152B of tubes between the second panel 122B and the third panel 122C of heat members 114. In this case, the panels 122 of heat members 114 are equidistant from the tubes 104. It should be noted that the third panel 122C of radiant heat members 114 could take the form of a support member that has heating elements on two opposite sides to heat the tubes 104 on both sides of the third panel 122C.

The housing 102 of the reactor 150 has a lining 154 along an interior surface 156 thereof. The lining 154 may be provided to shield or insulate the housing 102 from the heat produced by the heat members 114 to prevent overheating the housing 102 and to prevent the housing 102 becoming unsafe. A jacket can alternately or additionally be used on the outside of the housing 102 to prevent unsafe exposure to the hot surface of the housing. To improve utilization of radiant energy within the housing 102, the lining 154 may have a reflective inner surface.

In general, the structures of the reactors 100 and 150 that are exposed to extreme temperatures are made of materials that can withstand such temperatures. The housing 102 may, in some cases, be exposed to internal temperatures exceeding 1,500° F. Thus, the housing may be made of a metal or non-metal material that can withstand such temperatures, such as ceramics, high melting metals such as tungsten, molybdenum, tantalum, and other thermally resistant materials described herein. The lining 154 can be made of a refractory material such as silica, fire brick, clay, ceramics such as alumina, zirconia, ceramic fiber, and the like, high melting metals such as the metals listed above, or other thermally resistant materials. Alloys of high melting metals, and mixtures of various high melting materials, can also be used. All of the reactors described herein may optionally have a lining such as the lining 154. The tubes 104, which may encounter temperatures as high as 2,000° F. in some cases, are made of materials that can both withstand high temperatures and can conduct thermal energy. These metals can be alloys of chromium and nickel, for example, potentially with other minor components such as niobium, titanium, and tungsten. Such materials are generally commercially available.

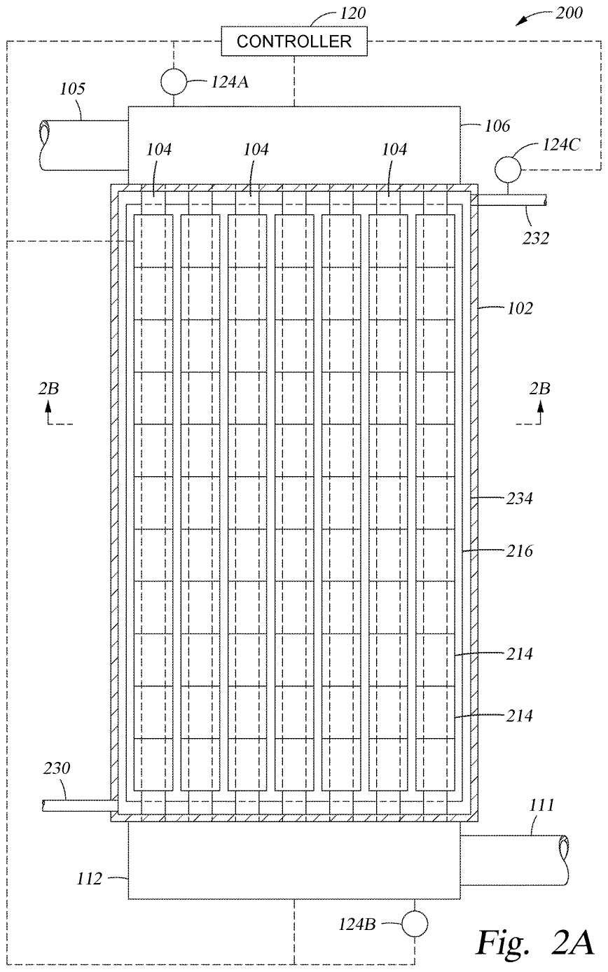

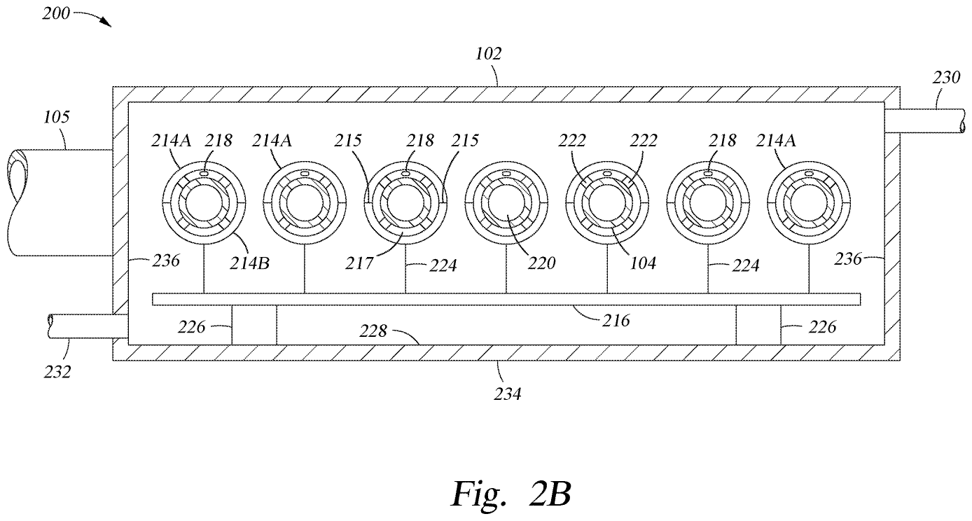

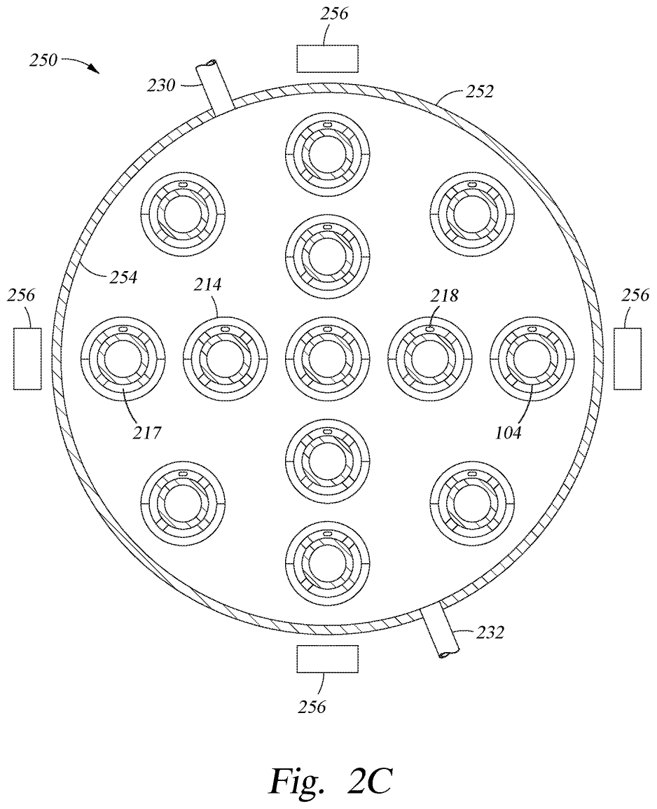

FIG. 2A is a schematic cross-sectional view of a reactor 200 according to another embodiment. The reactor 200 is similar to the reactors 100 and 150, but with a different version of radiant heat members. In this case, each of the tubes 104 is surrounded along all or part of its length by a plurality of radiant heat members 214. Each radiant heat member 214 is made of a material that, like the heat members 114 of the reactors 100 and 150, emits radiant energy from ohmic heating when an electric current passes through the material. Each radiant heat member 214 surrounds one of the tubes 104, and an inner surface of each radiant heat member 214 is spaced apart from the outer surface of the respective tube 104 to create an annular space between the radiant heat member 214 and the tube 104 outer surface to allow radiant energy to heat the outer surface of the tube 104. Each of the radiant heat members 214 has a shape that can be selected according to the needs of particular processes. In one case, each radiant heat member 214 has a cylindrical inner surface to match the shape of the tube 104 surface and a rectangular outer surface. The radiant heat members 214 may be made of separable parts, for example two, three, or more separable parts, to facilitate installation and removal of the heat members 214 around the tubes 104. Each part of each heat member 214 can be separately energized by electric current, or the parts of one heat member 214 may be electrically coupled to provide a common power circuit for the entire heat member 214. The reactor 200 includes an electrical interface 216 that electrically couples with each of the radiant heat member 214 to supply electricity. The reactor 200 includes the feed distributor 106 and product plenum 112, as in the reactors 100 and 150.

Each radiant heat member 214 extends a short distance along the length of its respective tube 104, defining a heating zone of the reactor 200. Each radiant heat member 214 may be individually and separately coupled to electrical power using the electrical interface 216 so that each radiant heat member 214 can be separately controlled. In this way, thermal profile of each tube 104 in the reactor 200 can be tailored to meet any objective. For example, all the radiant heat members 214 can be operated to maintain a temperature in each heating zone at the same target temperature. Alternatively, the radiant heat members 214 can be operated to provide any desired heating pattern, such as longitudinal gradients, lateral gradients, and other patterns.

The radiant heat members 214 may have an inner radiator that is enclosed by a thermally resistant material. Enclosing the radiator in a thermally resistant material may recover more emitted radiant energy into the tubes 104 as thermal energy where, without such enclosure significant radiant and/or thermal energy would be emitted into the interior of the housing 102 with little benefit in driving chemical reactions within the tubes 104. The enclosures may be an insulating material that is coupled to the radiator. The radiator, which may be coupled to an inner surface of the enclosure, can be a metal material that conducts electricity but provides a useful resistance for ohmic heating, and can withstand high temperatures. Various types of Nichrome metal can serve this purpose, along with other materials. Capturing radiant and/or thermal energy that would otherwise be emitted into the housing interior, and confining that energy to direct more of that energy into the tubes 104 can reduce the electrical power needed to achieve a target thermal condition within the tubes 104. The enclosure can be a high melting metal or ceramic material, such as a metal oxide material or mixed metal oxide material, or another thermally resistant material described herein. To improve capturing radiant energy emitted by the radiant heat members 214, the enclosure can have a reflective inner surface.

The radiant heat members 214 of one tube 104 are in abutting relationship, one to the other along the length of a tube 104. Thus, in this case there is essentially no space between one radiant heat member 214 and the next along a single tube 104. In other cases, the radiant heat members 214 can be spaced apart in the longitudinal direction of the plurality of tubes. In cases where the radiant heat members 214 are spaced apart along the tubes 104, in the longitudinal directions of the plurality of tubes 104, the tubes 104 may be covered in the spaces using an insulating material to avoid significant heat loss. The insulating material may be any of the materials mentioned above as high melting materials, or any material that has a melting point approximately higher than that of the tubes 104 themselves.

In cases like the reactor 200 of FIG. 2A where the tubes 104 are essentially entirely enclosed by the radiant heat members 214 so that heat emission is localized within the interior of the radiant heat members 214, the interior of the housing 102 may be cooled or temperature controlled by flowing a gas through the interior of the housing 102. For example, a gas inlet 230 can provide a path to flow a cooling gas into the housing 102, and a gas outlet 232 can evacuate gas from the housing 102. Here, the gas inlet 230 and gas outlet 232 are at opposite longitudinal ends of the housing 102, but any suitable configuration can be used. One or more thermal sensors (not shown) can be located within the housing 102 to monitor a thermal condition within the housing, and a controller can be configured to receive signals from such thermal sensors and adjust flow of the cooling gas to target a housing internal temperature, or other desired parameter.

Using a gas flow to moderate temperature within the housing, without substantially adding to the heating load of the radiant heat members 214, can reduce exposure of structures of the reactor 100 within the housing 102, for example an electrical interface like the interface 216, to extreme temperatures. As before, the housing 102 can have an interior lining 234. Use of an interior lining is optional for all the reactors described herein, as is use of flush gas within the housing in cases with suitable radiant heat design.

The optional gas analyzers 124A and 124B are included in the reactor 200. In this case, a third gas analyzer 124C is coupled with the gas outlet 232 to provide the capability to monitor composition of the cooling gas flowing through the housing 102. Signals from the third gas analyzer 124C can be used, for example, to determine whether carbon containing species are present in the cooling gas. Thus, if a carbon-free gas, such as nitrogen, is used as a flush or cooling gas in the reactor 200, such gas can also provide the capability to detect leaks from any of the tubes 104 into the housing 102 by detecting carbon-containing gases at the gas outlet.

FIG. 2B is a top view of the reactor 200, similar to the top view of FIG. 1B. The reactor 200 has the tubes 104, which are to be filled with catalyst. Here there is only one rank of tubes 104, so all the tubes 104 are arranged in a substantially parallel and coplanar arrangement, like in the reactor 100 of FIG. 1A. The tubes 104 are spaced uniformly within the housing 102 to maximize uniformity of processing within the tubes 104.

Each radiant heat member 214 is disposed around one of the tubes 104, completely surrounding the respective tube 104, with an inner surface 217 of each heat member 214 spaced apart from an outer surface 220 of the respective tube 104. As noted above, a radiator of each heat member 214 may be disposed at the inner surface 217. The tubes 104 are cylindrical in this case, so each of the radiant heat members 214, in this case, has a cylindrical inner surface. Thus, the space between each radiant heat member 214 and the respective tube 104 is, in this case, an annular space. Here, a plurality of standoffs 222 are provided to contact the inner surface 217 of the radiant heat member 214 and the outer surface of the tube 104 to maintain spacing between the two members. It should be noted that the outer surface of each tube 104 can have any shape, for example square, rectangular, hexagonal, or any suitable shape, and the tubes 104 of one reactor can have the same or different outer shapes.

The standoffs 222 can be continuous ridges that extend a portion, or all, of the axial length of the radiant heat member 214. Alternately, the standoffs 222 can be discontinuous, like posts or small ridges. Shown here, the standoffs 222 are arranged in a pattern around the tube 104, each standoff 222 spaced an angular distance of 90° from two neighboring standoffs 222, but the standoffs 222 can be arranged in any convenient pattern. Spacing can be maintained using any suitable means. In one alternate embodiment, each radiant heat member can have a collar at each end thereof that contacts the outer surface of the tube 104. Thus, the radiant heat member would have a cylindrical portion with inner diameter larger than an outer diameter of the tube 104, so that an annular space can be defined, and the radiant heat member would have a collar at each end thereof with inner diameter approximately equal to the outer diameter of the tube 104 to maintain position of the radiant heat member with respect to the tube 104.

The radiant heat members 214 may have a piecewise construction, so the radiant heat members 214 can be assembled and disassembled to facilitate installation around, and removal from, a tube 104. Here, each radiant heat member 214 disassembles into a first piece 214A and a second piece 214B at separation points 215, but any suitable arrangement can be used.

As described above, the radiant heat members 214 use a flow of electric current to produce ohmic heat. The radiator, or radiators, can be oriented along a length of the radiant heat member 214, or along the circumference, for example the inner circumference, of the radiant heat member 214, or a combination thereof. Electricity is separately provided to each radiant heat member 214, in this case, by a dedicated lead 224 from the electrical interface 216. Because, in this case, the radiant heat members 214 extend along a longitudinal direction of the plurality of tubes and are also distributed along the longitudinal direction of the plurality of tubes, the electrical interface 216 extends longitudinally and laterally along one side of the tubes 104 to provide individual electrical connections for each radiant heat member 214. Controllable electrical supply to each radiant heat member 214 is readily accomplished using suitable circuitry within the electrical interface 216.

Here, the electrical interface 216 is illustrated as a panel, but the electrical interface 216 could have any suitable configuration. For example, the electrical interface 216 could be, or could comprise, a plurality of bars, extending longitudinally, laterally, or any suitable direction, or combination thereof, to support circuitry and/or wiring for electrical supply to the radiant heat members 214. Alternately, or additionally, the electrical interface 216 could be, or could include, a plurality of posts to support circuitry. Any suitable configuration can be used. Also, here, the electrical interface 216 is shown located within the housing 102, spaced apart from the walls of the housing 102. The housing 102, in this case, has a rectangular profile in cross-section, with two opposite large inner surfaces 228 connected to two opposite small inner surfaces 236. The electrical interface 216 can be supported, in this case, by attaching supports 226 to the large inner surface 228 of the housing 102 and to the electrical interface 216, in any suitable manner. Two supports 226 are shown here extending from the large inner surface 228 of the housing 102 in a direction perpendicular to the electrical interface 216. In other cases, the electrical interface 216 can be located against the large inner surface 228 of the housing 102, in direct contact with the large inner surface 228, or anywhere outside the housing 102. In other cases, the electrical interface can have multiple members located at different locations inside and/or outside the housing 102.

Each of radiant heat members 214 has a thermal sensor 218 to sense thermal condition of the thermal zone of the radiant heat member 214. Here, the thermal sensors 218 are located near the inner surface 217 of the radiant heat member 214 to sense the thermal condition at the radiator of the radiant heat member 214, which faces the outer surface 220 of the respective tube 104. The thermal sensors 218 can be any of the thermal sensors mentioned above, and placed here can sense the thermal condition of the emitting surface of the radiant heat member 214 and/or the absorbing outer surface 220 of the tube 104. Power and signal service can be provided to the thermal sensors 218 by the electrical interface 216 through the leads 224.

FIG. 2C is a top view of a reactor 250 according to another embodiment. The reactor 250 has a cylindrical configuration with a cylindrical housing 252 that encloses a plurality of tubes 104 in a generally circular arrangement. The tubes 104 are configured like the tubes 104 of the reactor 200, with cylindrical radiant heat members 214 surrounding the tubes 104 and a thermal sensor 218 disposed adjacent to the inner surface 217 of the radiant heat members 214. Here, four electrical interfaces 256 are arranged along the outer surface of the housing 102, which has an optional interior lining 254. The four electrical interfaces 256 allow convenient routing of power and signals (using conduits not shown) to the radiant heat members 214 and thermal sensors 218, which are uniformly distributed within the circumference of the housing 252. Since the heating mode of the tubes is substantially contained and localized within the radiant heat members 214, arrangement of the reactive units, tubes 104 surrounded by radiant heat members 214, is reasonably arbitrary, and could be considerably denser than depicted in FIG. 2C.

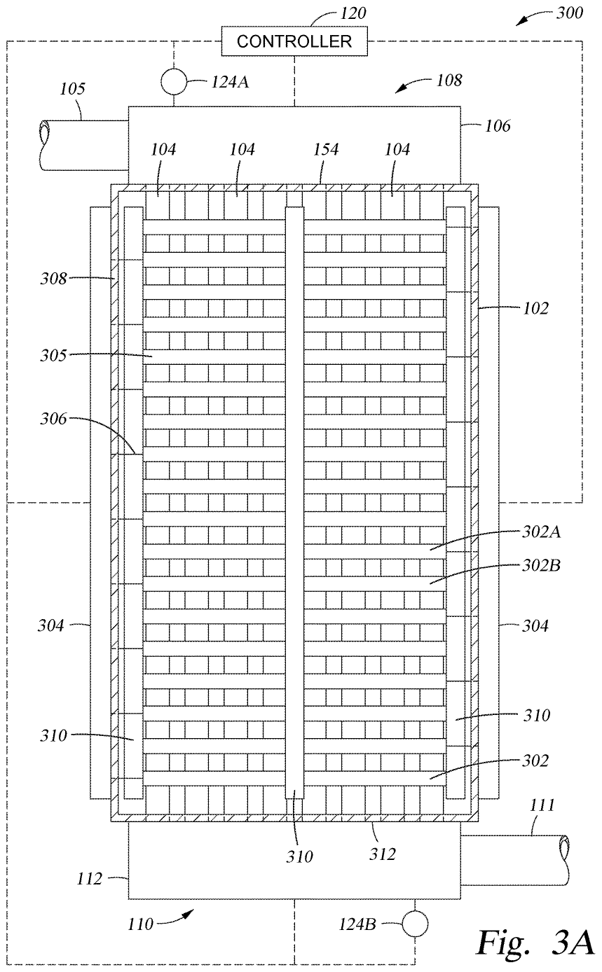

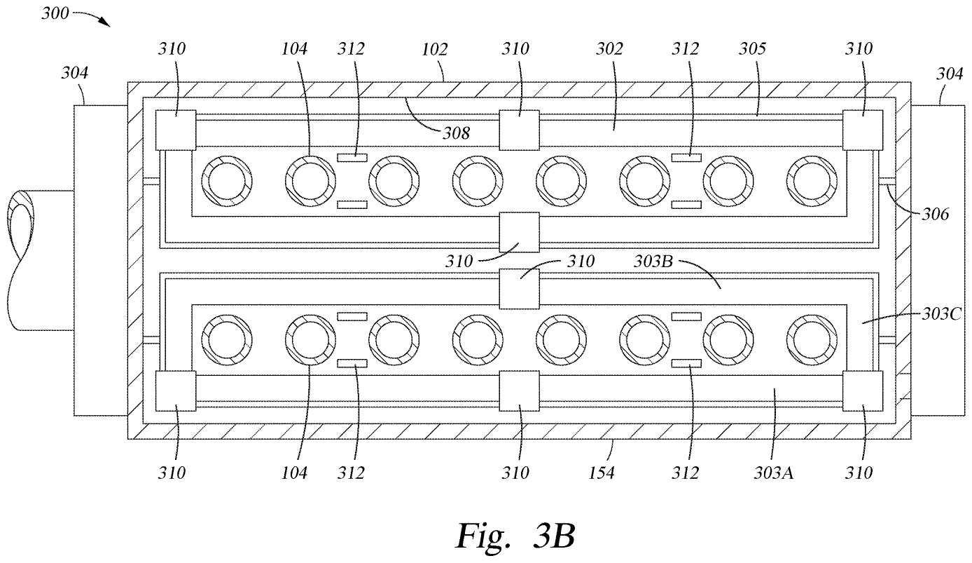

FIG. 3A is a schematic cross-sectional view of a reactor 300 according to another embodiment. FIG. 3B is a schematic top view of the reactor 300 of FIG. 3A. The reactor 300 has the housing 102, in this case also with the lining 154, and within the housing 102 a plurality of the tubes 104. The tubes 104 are arranged in two substantially parallel coplanar groups, each group of tubes 104 arranged along a plane. Each group of tubes 104 is heated using a plurality of radiant heat members 302 that extend partially around a portion of the tubes 104 of one group. Each radiant heat member 302 has three segments, a first segment 303A that extends laterally along a first side of the group of tubes 104 in a first direction transverse to the longitudinal direction of the plurality of tubes 104 and substantially parallel to the plane defined by the group of tubes 104, a second segment 303B that extends laterally along a second side of the group of tubes 104, opposite from the first side, in a direction that is substantially parallel to the first direction. The first and second segments 303A and 303B are joined by a third segment 303C that is substantially perpendicular to the first and second segments. The third segment 303C is located at an edge of the group of tubes 104. Thus, each radiant heat member 302 extends along the group of tubes 104 from a central region of the group of tubes 104 along one side thereof, around the edge of the group of tubes 104, and along the group of tubes 104 toward the central region along the other side. Two such radiant heat members 302 are arranged facing each other to provide heat to a heating zone of the tubes 104. A plurality of these radiant heat members 302 are distributed along the longitudinal direction of the plurality of tubes 104. In the reactor 300, two such reaction units (group of tubes 104 with radiant heat members 302) are disposed in the housing 102. For each reaction unit, the radiant heat members 302 are distributed along the longitudinal direction of the plurality of tubes 104 of the reaction unit.

The radiant heat members 302, in this case, have a generally rectangular shape, the third segment 303C being a straight rectangular segment that connects to the first and second segments 303A and 303B, each of which is also a straight rectangular segment, at right-angle corners. The heat members 302, thus, have a rectangular u-shape, with free ends supported by the supports 310 at the central region of the housing 102 and corners supported by the support 310 at the corner areas of the housing 102. The support 310 can have cavities or shelves that receive portions of the heat members 302, the free ends or the corners thereof, to support the heat member 302. The heat members 302 emit radiant energy to heat the tubes 104. In this case, surfaces of the heat members 302 facing away from the tubes 104 can be provided with an insulating or reflective layer 305 to capture and/or direct any thermal energy radiated away from the tubes 104 and redirect that thermal energy toward the tubes 104 or back to the radiant heat member 302 to augment the radiant energy emitted towards the tubes 104. Where the layer 305 is a reflective layer, at least the surface of the layer 305 facing the radiant surface of the radiant heat member 302 is reflective. Use of the layer 305 can reduce the emission required from the radiant heat members 302 to supply sufficient thermal energy to the tubes 104 and can also reduce thermal exposure of interior structures of the reactor 300, such as the housing 102, lining 308, and supports 310.

In other cases, the radiant heat members 302 could have different shapes. For example, the third segment 303C could be curved rather than straight and could connect to the first and second segments 303A and 303B at corners that are not right-angle corners, forming for example obtuse-angle corners. In other cases, the third segment 303C could connect to the first and second segments 303A and 303B at rounded corners. Thus, a curved third segment 303C could connect to the first and second segments 303A and 303B at rounded corners. In another case, the third segment 303C can have a circular shape to follow the circular circumference of the tube 104 at the edge of the tube group. Thus, a radiant heat member 302 can have a first segment 303A that is a straight rectangular segment, a second segment 303B that is a straight rectangular segment, and a third segment 303C that is a semicircle to connect the first and second segments 303A and 303B. Using a circular third segment 303C can improve uniformity of radiant heating of the tube 104 at the edge of the tube group because the emitting surface of the third segment 303C is a constant distance from that tube 104. The first and second segments 303A and 303B can likewise have emitting surfaces that are shaped to improve uniformity of radiation. For example, the first and second segments 303A and 303B can have scalloped emitting surfaces with circular portions that follow the circumference of the tubes 104 to provide emitting surfaces, a portion of which are spaced apart from the tubes 104 at a constant distance.

Here, each radiant heat member 302 has two thermal sensors 312. As in other embodiments herein, the thermal sensors are located at radiation emitting surfaces of the radiant heat members 302 to sense a thermal condition at the radiation emitting surface. Signals from the thermal sensors 312 can be used to resolve a temperature at the radiation emitting surface, a thermal flux at the radiation emitting surface, a thermal flux through the walls of the tubes 104, and a temperature within the catalyst inside the tubes 104. Here, the two thermal sensors 312 of each radiant heat member 302 are disposed at a relatively central location of the reaction unit, on a surface of the first and second segments 303A and 303B, to provide signals that can be used to infer thermal conditions for the entire reaction unit. The thermal sensors 312 of one radiant heat member 302 are aligned, in this case, but they could be staggered in other cases. Power and signal service is provided to the thermal sensors 312, as with the other embodiments herein, by electrical coupling with an electrical interface 304.

The reactor 300 has electrical interfaces 304 disposed outside the housing 102 for supplying electrical power to the radiant heat member 302. The electrical interfaces 304 can be electrically coupled to the radiant heat member 302 in any suitable way, and can be located in the interior of the housing in some cases. Here, leads 306 couple the electrical interfaces 304 to the radiant heat members 302 through the housing 102 wall. Like the other reactors herein, the reactor 300 may use a lining 308, which may have a reflective inner surface. The reactor 300 may also, or instead, use thermal containment for the radiant heat members 302 that has a reflective inner surface.

Supports 310 can be provided within the housing 102 to support the radiant heat members 302. In this case, the supports 310 are vertical supports, like posts or pillars, that extend along the longitudinal direction of the housing 102 or the tubes 104 from a floor (not visible in FIG. 3A) of the housing 102. The supports 310 can attach to the radiant heat members 302, or the support 310 can merely provide surfaces on which the radiant heat members 302 can rest. Here, each radiant heat member 302 is supported at three corners. Two supports 310 support each radiant heat member 302 at the ends of the first and second segments 303A and 303B and a third support 310 supports each radiant heat member 302 at a corner where the first or second segment 303A or 303B connects with the third segment 303C.

The tubes 104 are shown in FIG. 3A coupled with the feed distributor 106 and the product plenum 112, as in all the other reactors described herein. In FIG. 3A, one reaction unit (tubes with radiant heat members) is visible that has 8 tubes 104. In FIG. 3B, two reaction units are visible, each reaction unit having 8 tubes 104. This is a different number of tubes 104 in a reaction unit from other reactors described herein, and any suitable number of tubes 104 can be used in a reaction unit.

Referring again to FIG. 3A, the radiant heat members 302 are distributed along the longitudinal direction of the plurality of tubes 104, and are spaced apart in this embodiment, so that each radiant heat member 302 is separated from one or two neighboring radiant heat members 302. In one case, the radiant heat members 302 are separated, one from another, by a distance that is about ⅓ the width of the radiant heat member 302 in the longitudinal direction of the housing 102 or the tubes 104. The radiant heat members 302 shown in FIG. 3A are separated, one from another, by a distance that is about the same as the width of the radiant heat member 302 in the longitudinal direction of the housing 102 or the tubes 104. As in other embodiments herein, here the radiant heat member 302 could be in abutting relationship, one to the other, or could be spaced apart any suitable amount. The supports 310 are visible in the background of this view, and as described above, extend in the longitudinal direction of the reactor 300, the housing 102, and the tubes 104, from the floor 313 of the housing 102 to a height sufficient to provide support for all the radiant heat members 302. The radiant heat members 302 can be supported within the housing in any suitable way. For example, individual supports can be attached to the inner surface of the housing 102, along the side thereof, to extend laterally into the interior of the housing 102 to provide support for each radiant heat member 302. Alternately, or additionally, supports can extend from the ceiling of the housing along the longitudinal direction of the reactor 300 to provide “hanging” support for the radiant heat members 302. Any suitable support mechanism can be used.

As can be seen in FIG. 3A, a first portion of the radiant heat members 302 are electrically coupled to an electrical interface 304 while a second portion of the radiant heat members 302 are not electrically coupled to an electrical interface 304. The radiant heat members 302 comprise a plurality of first radiant heat members 302A that are made of an electrically conductive material, such as a metal or metalloid carbide, or mixture thereof, that will emit thermal radiation upon ohmic heating. The radiant heat members 302, in this case, also comprise a plurality of second radiant heat members 302B that are made of any of the thermally resistant materials described herein. The first radiant heat members 302A are electrically coupled to an electrical interface 304 by leads 306 to receive electric current. The second radiant heat members 302B are not electrically coupled to an electrical interface 304. The second radiant heat members 302B's function is to absorb radiant energy from the first radiant heat members 302A and re-radiate thermal radiation to supply thermal radiation to a heating zone of the tubes 104. In this case, the first and second radiant heat members 302A and 302B are arranged in alternating relationship in the longitudinal direction of the reactor 300, the housing 102, and the tubes 104 so that every other radiant heat member 302, in the longitudinal direction, is coupled to an electrical interface 304. As noted above, the insulating or reflective layer 305 is visible here on a surface of the radiant heat members 302A and 302B facing away from the tubes 104.

The radiant heat members described herein are generally made of thermally resistant material that may be electrically conductive. For example, the radiant heat members 114 of FIG. 1A may be silicon carbide bars or rods that can conduct electricity to an extent suitable to create resistive heat and emit thermal radiation for heating. Electrodes are coupled directly to the silicon carbide material of the members to deliver electric current into the members. Any of the radiant heat members described herein can be made of silicon carbide and energized in the same way.

The radiant heat members may also be made of silicon carbide, for example in the form of silicon carbide rods. A silicon carbide rod may be configured to conduct electricity directly, as with the silicon carbide members above, or each silicon carbide rod may include a wire made of a more conductive material to facilitate equalizing electric current through the silicon carbide material along the entire length of the rod. For example, the radiant heat members 214 in FIGS. 2B and 2C may be silicon carbide rods. Each of the radiant heat members 214 may include electrodes at the opposite ends of the heat member to facilitate applying electric power to the wires within the silicon carbide rods or to the rods themselves. Any of the radiant heat members described herein can be made of such silicon carbide materials.

The radiant heat members may also be made of ceramic materials in general such as metal oxides, nitrides, and carbides, and mixtures thereof. Silicon carbide and nitride, along with boron nitride, can be combined in any suitable way and used to make radiant members that can be energized electrically. The radiant heat members can also be sheathed heat members, with a heating element disposed within an outer sheath, which may be metallic, ceramic, or other suitable material. In one embodiment of such a sheathed heating member, an electrical conductor with selected resistance is disposed within a metal sheath. Where less conductive materials are used, the radiant heat members can include conductors to facilitate delivery of electricity through the materials. For example, the radiant heat members 302 in FIGS. 3A and 3B may be made of a ceramic material, which may be conductive or non-conductive, or of any other thermally resistant material described herein. Where the radiant heat members 302 are made of non-conductive material, conductors such as wires and strips can be disposed within the body of the radiant heat member to conduct electricity into the interior of the non-conductive material to facilitate heating.

Radiant heat members made of materials described herein, and/or sheathed radiant heat members, can be obtained from Kanthal® Corp. of Amherst, New York, for example the Kanthal Globar® SiC products.

Use of the radiant heat members described herein enables control of the endothermic reactions taking place inside the catalyst-filled tubes by measuring thermal conditions outside the tubes. As noted above, thermal conditions at the emitting surface of the radiant heat members can be used to infer thermal conditions inside the tubes and/or thermal flux into the tubes as the endothermic reactions progress. Thermal sensors can be disposed in various locations of the reactors herein to monitor thermal conditions in different locations and to provide capacity to control the reactions. As shown herein, thermal sensors can be coupled to a portion of the radiant heat members used in these reactors, or to all of the radiant heat members used in these reactors. In some cases, more than one thermal sensor can be coupled to each radiant heat member. In other cases, the radiant heat members might have different numbers of thermal sensors, some having only one thermal sensor while others have more than one thermal sensor. Any suitable arrangement can be used to provide information at desired locations and having the desired granularity.

It should be noted that thermal sensors can also be disposed within the housing of the reactor to directly monitor a temperature of one or more of the tubes containing catalyst. In cases where a tube becomes partially or completely plugged and gas flow is significantly slowed or stopped within the tube, the cooling effect the flowing gas, and the endothermic reaction within the catalyst, has on the tube is lost and the tube can become overheated. Thermal sensors of any of the types mentioned above can be disposed within the housing to monitor temperatures at selected locations of all or a portion of the tubes to detect potential or actual overheating of tubes so remedial action can be taken.

In general, the apparatus described above supports methods of controlling endothermic gas reactions that can be performed in these reactors. The thermal sensors are used to measure temperatures within the reactor and a physical or statistical model is used to infer conditions within the reactor, predict performance of the reactor, and adjust temperatures, pressures, and/or flow rates within the reactor to achieve desired targets. The reactors described herein can be operatively coupled with controllers to receive signals from the various instruments described herein and to control electric current provided to the radiant heat members herein to control temperature, thermal flux, temperature profile, and the like. Such controllers can also be configured to adjust pressure and/or flow rate within the reactors, and within the tubes 104, based on signals from thermal sensors and composition sensors such as gas analyzers

In one method, a feed gas is supplied to a reforming reactor such as any of the reactors described herein. A thermal condition is measured at a plurality of locations of the reactor, and an electric radiant heater is adjusted based on the measured thermal condition. The thermal condition can be a temperature within a vessel, such as any of the tubes 104 described above, where the reaction is taking place or the thermal condition can be outside such vessel. The method can include determining, or inferring, a temperature inside the vessel where the reaction is taking place from a measurement outside the vessel.

A reaction model can be used to determine the adjustment to be made to the electric radiant heater. The reforming reactor generally produces syngas from carbon-containing gases, as described above. The kinetics and thermodynamics of such reactions are known, and physical models are available that can be used to predict conversions of various species based on temperature and catalyst condition. Statistical models such as machine learning models can also be used to relate measurements of temperature, pressure, and composition. In some cases, inlet and outlet gas composition can be measured, and thermal conditions can be measured at various locations of a reactor, and a physical model, statistical model, or combination thereof, can be used to determine or infer catalyst condition.

Where catalyst condition can be inferred or determined, a catalyst activity parameter can be determined and tracked to represent a trend in catalyst performance. Using such a parameter, an end point can be predicted at which catalyst performance will no longer be satisfactory and remedial action can be taken.

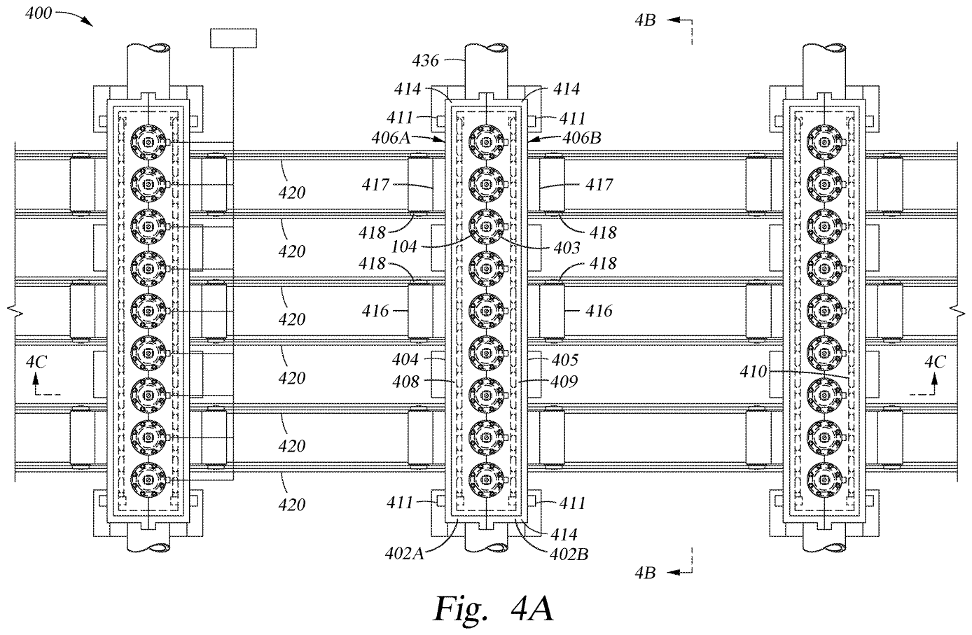

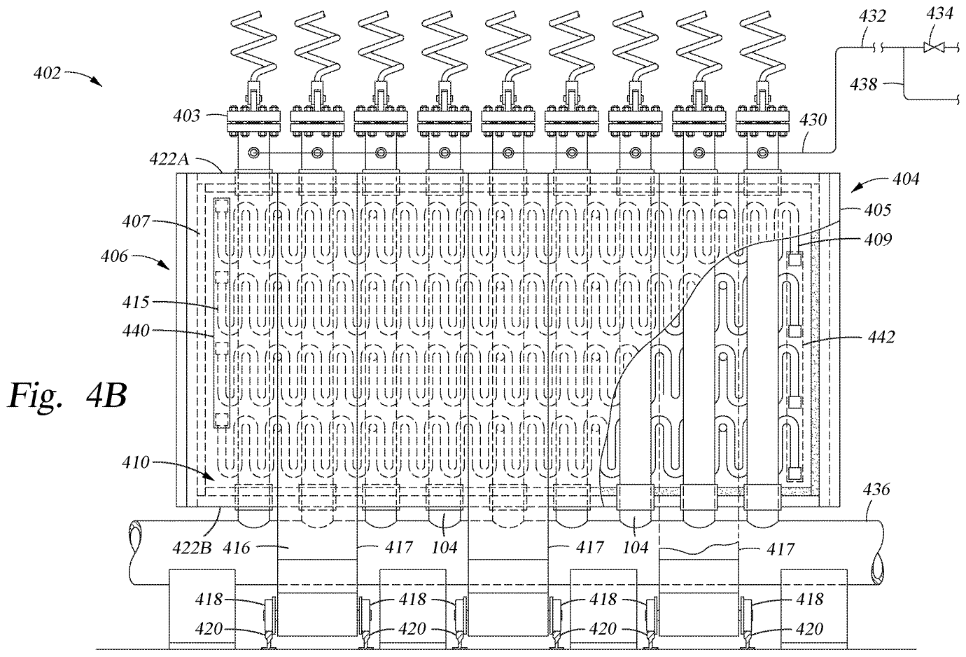

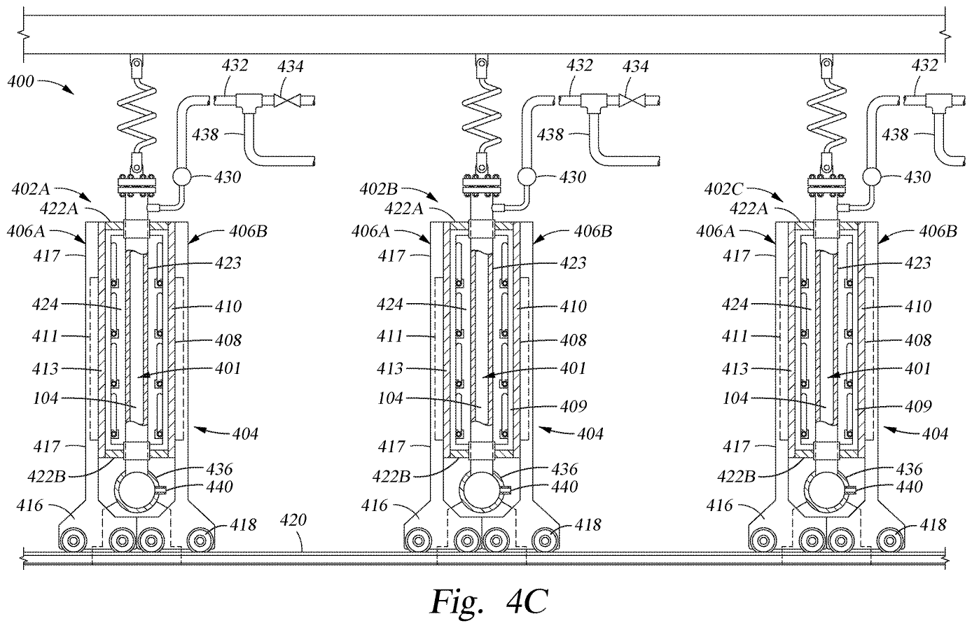

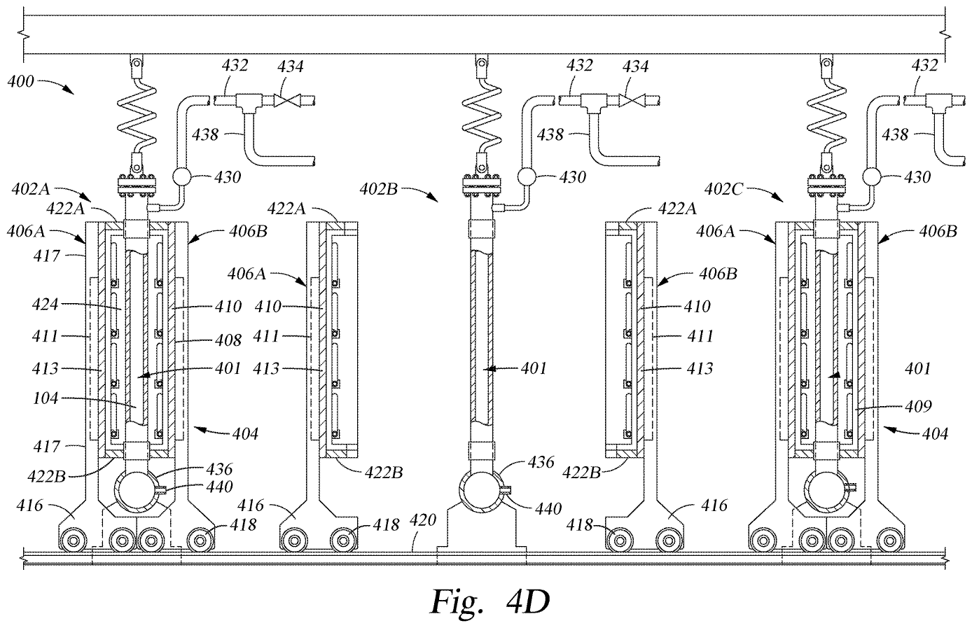

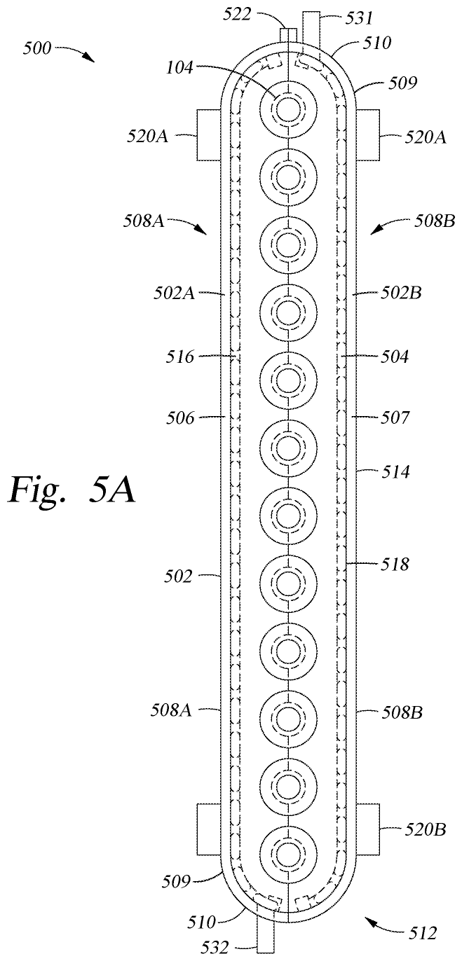

FIG. 4A is a schematic top view of a reactor facility 400 according to one embodiment. The reactor facility 400 has a plurality of reactors 402, each reactor 402 having a plurality of the tubes 104, in substantially parallel orientation, containing catalyst for performing an endothermic chemical reaction, and a heating structure 404 for supplying heat to the endothermic chemical reaction to take place within the tubes 104. Three reactors 402 are shown here, but any number of reactors 402 can be associated with a reactor facility of this kind.

In this version, the tubes 104 are disposed in a substantially vertical orientation, with the longitudinal axis of each tube extending vertically. The tubes 104 are shown here in phantom because a flange 403 of a supply manifold for supplying gas to each tube 104 of one reactor 402 obscures direct view of the tubes 104 in FIG. 4A. The heating structure 404 of each reactor 402 comprises a first heating structure member 406A and a second heating structure member 406B that engage to form the heating structure 404. In this case, each of the first and second heating structure members 406A and 406B has a wall portion 408 with a heating side 410 that faces the tubes 104, and two end portions 412 that extend from opposite edges 414 of the wall portion 408, from the heating side 410 of each member 406A and 406B toward the tubes 104. Here, when the heating structure members 406A and 406B are engaged for operation, the end portions 412 make contact and abut to form an enclosure between the heating structure members 406A and 406B to enclose the tubes 104. As noted above, the tubes 104 contain catalyst, which resides in a catalyst containing portion 401 (FIG. 4B). The heating structures 404 formed by the heating structure members 406A and 406B are configured to enclose the catalyst containing portion 401 of the tubes 104 to drive the endothermic reaction within. All the heating structures described herein are so configured.

Here, each heating structure member 406A and 406B comprises a housing member 405, a heating element structure 409, and a refractory member 407 between the housing member 405 and the heating element structure 409. The heating element structure 409, and all the heating elements and heating structures herein, have electrically powered radiant emitters that emit thermal energy to heat the reactors. The refractory member 407 is disposed along the wall portion 408 of the housing member 405 at the heating side 410 facing the tubes 104. The refractory member 407 is made of a refractory material, such as ceramic or a high-melting metal, for example any metal oxide material, silicon carbide, tungsten, or any of the heat resistant materials described elsewhere herein, such that the refractory member is capable of withstanding the environment of high thermal energy at the heating side 410 of the respective heating structure member 406A and 406B. The heating element structure 409 of each respective heating structure member 406A and 406B is attached at the heating side 410 of the respective heating structure member 406A, 406B, which in this case is the inward facing surface of the refractory member 407. The heating element structure 409 may be attached to the refractory member 407, or may penetrate the refractory member 407 and be attached to the housing member 405. The refractory member 407 may be a separate, removable member or a member attached to the housing member 405, such as a lining or surface panel adhered to the housing member 405. In some cases, the housing member 405 may itself be made of a refractory material such that a separate refractory member 407 is not used. The refractory member 407 may be made to have less overall mass than the housing member 405, which can be an attractive option to reduce cost. In cases where a refractory member 407 is used, the refractory member 407 may insulate the housing member 405 from exposure to high temperature, thus reducing thermal demand on the housing member 405. The surface of the heating structure members 406A and 406B, whether a surface of the housing member 405 or of a refractory member 407, may be made of a reflective material and may be polished to any suitable degree to increase reflectivity of thermal radiation within the enclosure of the heating structure members 406A and 406B.

heating side 410 The heating element structure 409 of each heating structure member 406A and 406B heating side 410 generates radiant thermal energy from electric power within the enclosure formed by the heating structure members 406A and 406B. The heating element structure 409 typically includes a plurality of heating elements (not shown in FIG. 4A) to generate radiant thermal energy from electric power. The radiant thermal energy heats the tubes 104, which in turn supply heat to the interior of the tubes 104 to heat the catalyst and reaction mixture within the tubes 104. Each heating element is electrically connected to at least two terminal members 411 to provide electric power to the heating element. Each heating structure member 406A and 406B has at least one terminal member 411 disposed at each lateral edge of each respective housing member 405A and 405B to provide a power circuit including the heating elements of the heating element structure 409. Electric power provided by the terminal members 411 flows through the heating elements generating resistive heat that radiates toward the tubes 104. Each heating structure member 406A and 406B is supported on a movable base 416, which in this case uses rollers 418 supported on a plurality of rails 420, by a support member 417, which is coupled to the movable base and to the housing member 405 at a surface opposite from the heating side 410 such that the heating structure members 406A and 406B are movable. Here, each heating structure member 406 is supported by three movable bases 416, each movable base 416 connected to the respective housing member 405 by a support member 417 connected to the movable base 416 at a central position thereof for stability. Generally, any suitable number of movable bases 416 can be used, and the number of movable bases 416 used in embodiments like that of FIG. 4A (and 4B) is selected to provide sufficient support to the heating element structures 409 to prevent deformation at high temperatures. Thus, the number of movable bases 416 can be four, five, six, or more, depending on the dimensions of the reactor facility 400.

The support members 417 stand vertically upright in this case, and each is like a post or wall that supports one of the heating structure members 406. In this case, a plurality of the support members 417 supports one heating structure member 406. Each base 416 extends laterally to provide support for the rollers 418, which are distributed in a movement direction of the heating structure 404. Each base 416 extends a distance in the movement direction of the heating structure members 406 to increase stability of the heating structure 404. In this case, each base 416 extends beyond a lateral extent of the heating structure member 406 to a location that is under the tubes 104. Where the support member 417 is like a wall, the base 416 may be a continuous member that extends the entire width of the support member 417 of the heating structure 404. Alternately, where the support member 417 is like a post, the base 416 may be a member having dimension similar to that of the support member 417. In the case shown in FIGS. 4A-4C, the support member 417 has dimensions somewhat smaller than the base 416 for extra stability. In such cases, a plurality of support members 417, each like a post, may attach to the wall portion 408 of a housing member 405 at a surface of the housing member opposite from the heating side 410. Such support members 417 may be attached to the two heating structure members 406 of one reactor 402, such that the bases 416 do not interfere or collide when the heating structure members 406 are moved into engagement position with the tubes 104.

FIG. 4B is an elevation view of a reactor 402 of the reaction facility 400 with one heating structure member 406 removed from the heating structure 404 of the reactor 402 to show interior features of the reactor 402. An inlet manifold 430 is coupled to the tubes 104 at an inlet of each tube to supply process gas to the tubes 104 of each reactor 402. The process gas undergoes reaction by contact with the catalyst in the tubes 104 at a target temperature maintained by the heating structure 404 of each reactor 402. A supply conduit 432 supplies process gas to the inlet manifold 430, which distributes the process gas among the tubes 104. A valve 434 can be coupled to the supply conduit 432 to stop flow of process gas to the tubes 104 in order to idle the tubes 104 for maintenance of the respective reactor 402. The location of the valve 434 can be selected to avoid subjecting the valve 434 to extreme temperatures that might compromise operation of the valve 434.

The process gas flows through the tubes 104 and is heated to a reaction temperature by the heating structure 404. The process gas reacts to produce a product gas that flows out of the tubes 104 into an outlet manifold 436 coupled to the tubes 104 at an outlet of each tube 104. The outlet manifold 436 collects the process gas for disposition to a downstream process. The outlet manifold 436 is coupled to an effluent conduit (not shown) which may also use a valve to stop flow through the effluent conduit when maintaining the respective reactor 402. Any valve used at the effluent conduit will be made of material resistant to high temperatures, such as high-melting metals and metal alloys. Such a valve can be located at a suitable location to avoid exposure to extreme temperatures.

Two heating structure members 406 are visible in FIG. 4B. A first heating structure member 406A is visible, and shown in partial cutaway to reveal the tubes 104 and a second heating structure member 406B behind the tubes 104. Each heating structure member 406 has a housing member 405, a refractory member 407, and a heating element structure 409. The heating element structure 409 features a plurality of heating elements 415, which are electrical conductors that radiate thermal energy as electricity flow through them. These heating elements 415 are in rod-over-bend configuration with protrusions 419 extending from the housing member 405 or the refractory member 407, at the heating side 410, to support the heating elements 415. These protrusions 419 may be provided at each overbend of the heating element 415, or only at some of the overbends as needed to provide sufficient support. The protrusions 419 may be configured in any suitable way to support the heating elements 415, and are made of material suitably resistant to high temperatures, such as ceramics or high melting metals and alloys. The protrusions 419 may also have retention features, such as hooked ends or c-ring shapes to secure the heating elements 415 in place.

Here, four heating elements 415 are shown extending across the heating structure member 406 between opposite edges 421 of the housing member 405 in the transverse direction of the tubes 104, which is the first direction described above, but any suitable number of heating elements 415 can be used. The heating elements 415 also traverse back and forth in bustrophedonic fashion along the heating side 410 of the heating surface member 406, in the longitudinal direction of the tubes 104, which is the second direction described above.

FIG. 4C is a schematic side view of the reaction facility 400 in partial cross-section. Each reactor 402 includes a first tube plate 422A and a second tube plate 422B, the first and second tube plates 422A and 422B disposed near both opposite ends of the tubes 104. The tube plates 422A and 422B extend in a direction transverse to the longitudinal direction of the tubes 104, and out from the heating side 410 of the respective heating structure member 406, to engage with each tube 104 of one reactor 402. The tube plates 422A and 422B, shown here in cross-section, along with an outer wall 423 of the tubes 104, define top and bottom annular gaps 425A and 425B around the tubes 104. The top and/or bottom annular gaps 425A and 425B can be sealed or covered. Here, a plug body 427 is disposed within the annular gaps 425A and 425B. In other cases, a cover can be used to cover one or both of the top and bottom annular gaps 425A and 425B. The plug body 427 and cover, if used, can be made of thermally resistant material, such as ceramic, glass, high melting metal or alloy, or fibers thereof.

The heating side 410 of the wall portion 408 of each heating structure member 406A and 406B may have a lining or coating 426 to facilitate directing the radiant thermal energy emitted by the electrically powered heating elements 409. When engaged in operation, the heating side 410 of each heating structure member 406A and 406B contacts the first and second tube plates 422A and 422B to enclose the tubes 104. The heating structure members 406A and 406B, along with the tube plates 422A and 422B, thus form an enclosure 413 around the tubes 104. The enclosure 413 thus formed can be configured to isolate the interior of the enclosure 413 to maintain an internal environment of the enclosure 413.

As noted above, the heating structure members 406A and 406B are each supported by a plurality of support members 417, each support member 417 extending from a movable base 416. The heating structure members 406A and 406B can move by function of the rollers 418 of the movable bases 416 rolling on the rails 420. The reactors in FIG. 4C are shown in a closed configuration for operation.

The tubes 104 are supported by a plurality of base members 428 disposed on the ground or on a lower support below the outlet manifold 436. The base members 428 are spaced apart to allow the movable bases 416 of the support member 417 of the heating structure members 406 to move under the outlet manifold 436. The base members 428 provide generally longitudinal support for the tubes 104 at a lower end of the tubes 104. Each tube 104 may also be supported at an upper end of the tubes 104 by a flexible support 429. The flexible support 429 generally provides lateral support for each tube 104, and may also provide some longitudinal support. A flexible support for each tube 104 can be useful to provide such lateral support where each tube 104 undergoes substantial dimensional change during thermal cycling. Any flexible support that can accommodate such dimensional change while providing at least lateral support for each tube 104 can be used.

FIG. 4D is a schematic side view of the reactor facility 400 in a different operative mode, with one reactor in an open configuration for maintenance. The three reactors of the reactor facility 400 are here labelled 402A, 402B, and 402C, with reactor 402B in an open state. Reactors 402A and 402C are closed with the heating structure members 406A and 406B engaged to form the heating structure 404 that encloses the tubes 104 for operation. Reactor 402B is open, the two heating structure members 406A and 406B of the reactor 402B having been moved away from the tubes 104 by rolling the heating structure members 406A and 406B in opposite directions along the rails 420. The reactors 402 (402A, 402B, and 402C) are spaced apart in the reactor facility 400 a distance selected to provide space between a heating structure 406A and/or 406B and the tubes 104 when the corresponding reactor 402 is in the open position for maintenance. The distance is sufficient such that when the reactor is in the open configuration, there is space enough between the heating structure members and the tubes to access both to perform maintenance and/or repairs. When such work is completed, the heating structure members can be returned to the operating configuration, engaging with each other to form the heating enclosure 413 around the tubes. It should be noted that the heating structure members 406A and 406B of one reactor 402 can move independently. Thus, the first heating structure member 406A can be moved away from the tubes 104 while the second heating structure member 406B remains in the operating position adjacent to the tubes 104, and vice versa.

Additionally, as noted above, when one or both heating structure members 406A and 406B are to be moved away from the tubes 104 into an open position, the reactor 402 can be first idled by closing the valve 434 to stop flow of process gas to the reactor 402. Here the valve 434 is shown relatively proximate to the reactor 402, but as noted above, the valve 434 can be located to avoid exposing the valve 434 to extreme temperatures. A flush gas inlet 438 can be coupled to the tubes 104, at the inlet thereof, the inlet manifold 430, and/or the supply conduit 432 (as shown here) to flow a flush gas through the tubes 104 when the reactor 402 is to be idled. The flush gas can remove process gases from the tubes 104, replacing the process gases with the flush gas inside the tubes 104. Here, the flush gas inlet 438 is shown coupled to the supply conduit 432 near the valve 434 to allow process gases to be removed from the entire feed system of the reactor 402. The flush gas can be an inert gas that will substantially prevent any reaction within the tubes 104 while the tubes 104 are idle. Appropriate valves and piping can be used to deliver flush gas to the flush gas inlet 438. A flush gas outlet 440 can also be coupled to the outlet manifold 436 (as shown here) and/or the tubes 104 at the outlet thereof to recover the flush gas.

In operation, when a reactor 402 is to be idled, where flush gas is used, a valve can be used to discontinue gas flow from the outlet manifold 436, and a flush outlet valve (not shown) coupled to the flush gas outlet 440 can be opened. Then, the valve 434 can be closed to discontinue flow of process gases to the tubes 104. Then, a flush inlet valve (not shown) coupled to the flush gas inlet 438 can be opened to flow flush gas into the tubes 104, to exit through the flush gas outlet 440. As with the valve 434, these flush gas valves can be located to avoid exposing the valves to extreme temperatures. The flush gas removes process gases from the tubes 104, replacing the processes gases with flush gas in the tubes 104, and stopping all reaction within the tubes 104. The flush gas inlet and outlet 438 and 440 can be closed to isolate the interior of the tubes 104, or flush gas can be continually flowed through the tubes 104 while the reactor 402 is open for maintenance and repairs.

To open the reactor 402, one or both heating structure members 406A and 406B are de-energized and moved away from the tubes 104, in this case by rolling along the rails 420. When the work is completed, the heating structure members 406A and 406B can be returned to operating configuration by rolling toward the tubes 104 to a location where the two heating structure members 406A and 406B are in engagement to form the enclosure 413 around the tubes 104. At that time, flush gas ports can be closed, the outlet manifold opened by operating the requisite valve, and process gases can be re-introduced to the tubes 104 by opening the supply valve 434. Upon energizing the heating structure 404, the reaction approaches a target temperature and the reactor effluent can then achieve a specified composition.

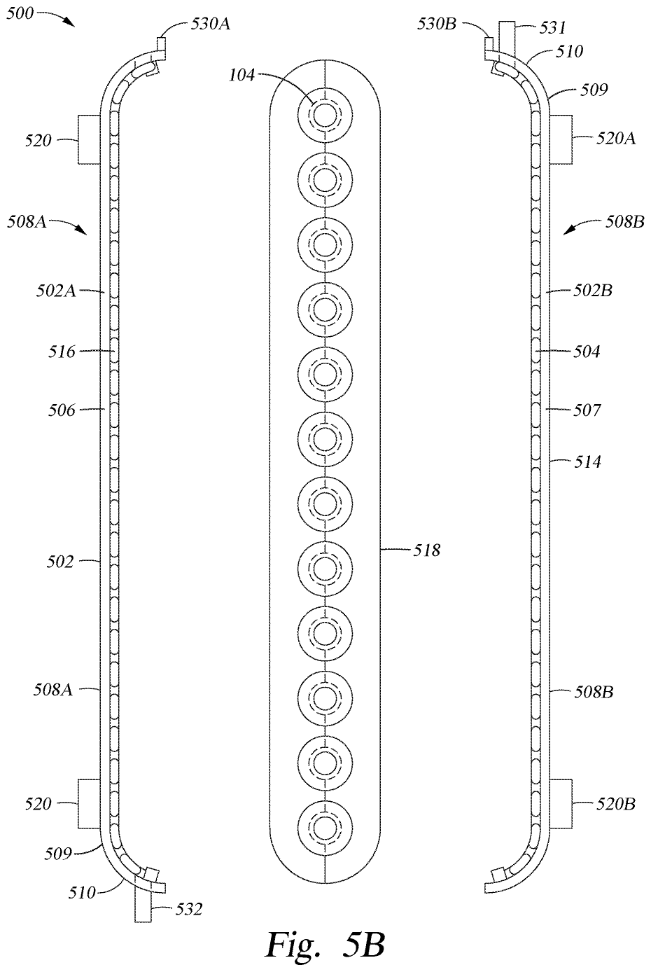

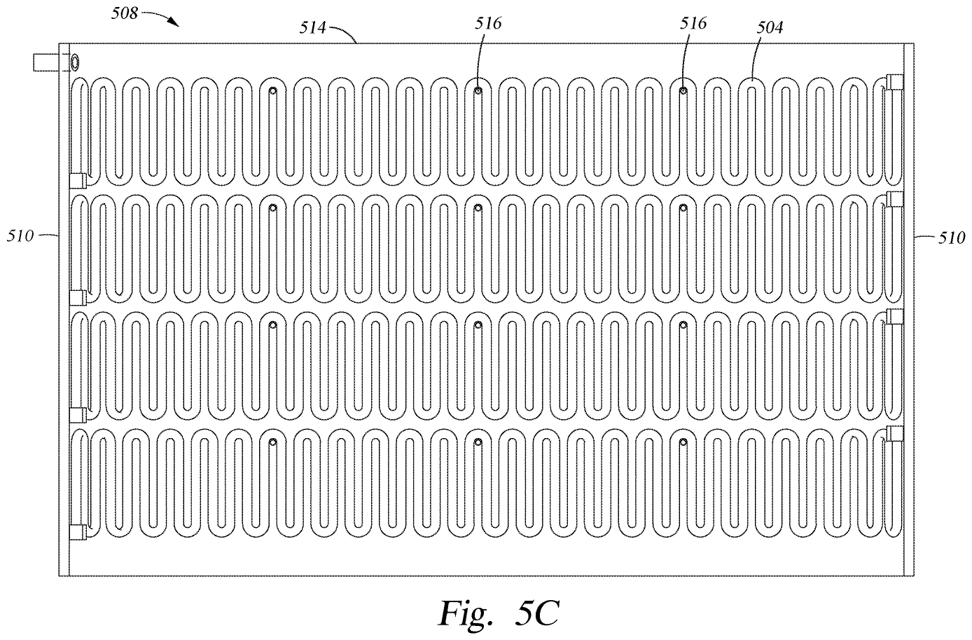

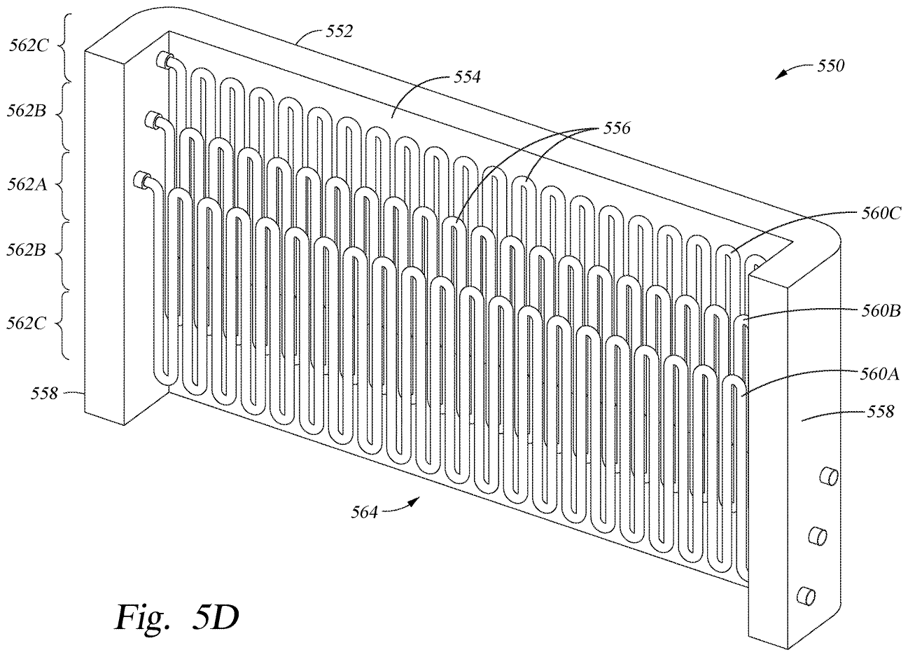

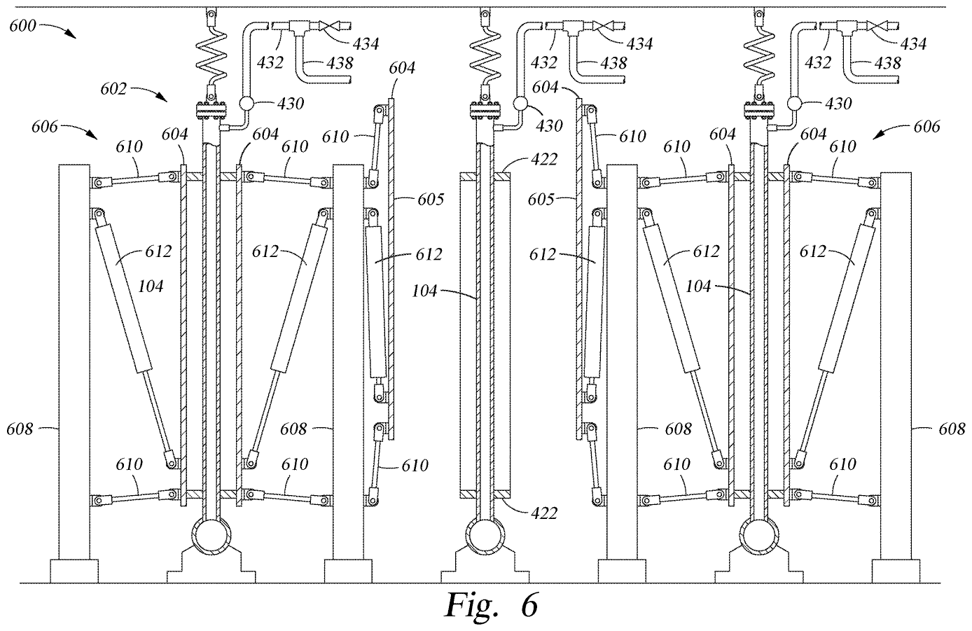

FIG. 5A is a schematic top view of a reactor 500 according to another embodiment. The reactor 500 is similar to the other reactors described herein, but with key differences. The reactor 500 can be used as the reactor 300 or as any of the reactors 402, or the other reactors described herein. The reactor 500 is like the reactor 300, and like any of the reactors 402, with a plurality of heating elements 504 distributed along a longitudinal direction of the tubes 104, all within a housing 502. The housing 502 includes a first housing member 502A and a second housing member 502B that engage together to form a heating enclosure 513, and can be separated like the other embodiments described herein to provide access to the interior of the reactor 500. The heating elements 504 are disposed along a heating side 506 of each of the first housing member 502A and the second housing member 502B. These heating elements 504 are typical of the heating elements used for all the reactors described herein and may be used with them all. The heating side 506 of each housing member 502A and 502B has an inner surface of a wall portion 507 of each member, that extends to an inner surface of end portions 510 of each member. The first housing member 502A, and the heating elements 504 coupled thereto, form a first heating structure member 508A. The second housing member 502B, and the heating elements 504 coupled thereto, form a second heating structure member 508B.

The first and second heating structure members 508A and 508B are radiant heating components that extend along both the longitudinal and transverse directions of the tubes 104. The end portions 510 of each of the heating structure members 508A and 508B are configured to engage with the end portions 510 of the other heating structure member. The end portions 510 extend from opposite edges 509, in the transverse direction of the tubes 104, of the wall portion 507 of each housing member 502A and 502B. The end portions 510 of each respective housing member 502A and 502B extend in the direction of the heating side 506 of each member 502A and 502B, and toward the tubes 104. Thus, the first heating structure member 508A has two end portions 510 located at opposite edges 509 of the first heating structure member 508A and the second heating structure member 508B has two end portions 510 located at opposite edges 509 of the second heating structure member 508B. The two end portions 510 of the first heating structure member 508A and the two end portions 510 of the second heating structure member 508B are configured to engage and attach to form, from the first and second heating structure members 508A and 508B, a heating structure 512 that encloses the tubes 104. The heating structure 512 comprises the heating elements 504 of the two heating structure members 508A and 508B, and the housing members 502A and 502B, which when engaged together form the housing 502.

Each heating structure member 508A and 508B has a substantially flat middle portion that extends in two perpendicular directions forming a substantially planar wall portion 514 similar in dimension to the wall portion 507 of the respective housing member 502A and 502B. The end portions 510 are at the opposite edges 509 of the wall portion 514 in the first direction of the wall portion 514, which as before is transverse to the longitudinal direction of the tubes 104 and substantially parallel to a plane defined by the group of tubes 104. The end portions 510, in this case, are curved in a cylindrical manner. The curvature of each end portion 510 extends about ¼ around the circumference of a cylinder, in this case, each curving toward the heating side 506 of the respective heating structure member 508 and toward the tubes 104. In a second direction of the wall portion 514, perpendicular to the first direction and substantially parallel to the longitudinal direction of the tubes 104, the wall portion 514 remains substantially flat to two opposite edges (not visible in FIG. 5A) of the wall portion 514 in the second direction. Thus, the curvature of each of the end portions 510 is about an axis that is parallel to the second direction, and is constant along the axis.

As described above, the end portions 510 of two heating structure members engage by abutment to form a heating structure 512 that encloses the tubes 104. Thus, the heating structure members 508A and 508B are disposed, relative to the tubes, such that the first direction of each heating structure member 508A and 508B is oriented transverse to the longitudinal direction of the tubes 104 and substantially parallel to the plane defined by the group of tubes 104. In this way, the heating structure 512 “wraps around” the sides of the tubes 104, with the heating elements 504 extending between the housing members 502A and 502B of the heating structure 512 and the tubes 104 to provide radiant energy for heating the tubes 104 and the contents therein.

The shape, described above, of the heating structure members 508A and 508B described above is one example of how such structures can be shaped. In other cases, the inner surface at the heating side 506 of the heating structure members 508A and 508B can be curved, as described above, while the outer surface of the heating structure members 508A and 508B is flat. In such cases, the outer surface of the middle portion 514 of each housing member 502A and 502B is planar, and extends to the edges 509 in a planar fashion. The outer surface then makes a corner at the edges 509, extending toward the heating side 506 of the respective housing member 502A and 502B. The two surfaces, the inner and outer surfaces of the heating structure members 506A and 506B, can also both be curved, but in different ways and to different extents. In other cases, the inner surface of the heating structure member 508 (A and/or B) can be planar with corners at the edges 509, while the outer surface is curved. Any suitable shape can be used. It should also be noted that the housing members 502 shown herein are depicted as being of uniform composition, but in some cases the housing members 502 can be formed from more than one piece of material, which can be attached together in any suitable manner, for example by welding, bolting, clamping, and the like.

The housing structure members 508A and 508B may have a closure structure 522 for fastening the two members 508A and 508B together when the two members 508A and 508B are engaged. The closure structure 522 may be a clamp, and the closure structure 522 may be configured to provide a closing force that urges the two housing structure members 508A and 508B together to form a seal between the two members. Configuring the two housing structure member 508A and 508B to seal allows control of the interior environment of the housing 502. For example, using a closure structure 522 to provide a seal for the housing 502 enables flowing a gas, for example an inert gas, into the housing 502 to create positive pressure within the housing 502. Such positive pressure can prevent process gases within the tubes 104 from escaping into the housing 502 interior in the event of a tube leak. In this case, one closure structure 522 is shown, on a side of the reactor 500 to join the two heating structure members 508A and 508B, but more than one closure structure can be used, for example on opposite sides of the reactor 500. One closure structure 522 is visible here, but any suitable number of closure structures 522 can be used to close the heating structure 508 of the reactor 500, and for all the reactors described herein. Thus, for example, two, three, four, or more closure structures 522 could be used in any of the reactors described herein, depending on dimensions of the reactor.

To flow a gas through the housing structure 502 when the heating structure members 508A and 508B are engaged, a gas inlet 531 and gas outlet 532 can be provided for fluid communication into and out of the interior of the heating structure 504. The gas inlet and outlet 531 and 532 provide fluid communication through the housing 502 from outside the housing to the interior of the housing so that a flush gas can be flowed through the gas inlet 531, through the interior of the housing 502, and out through the gas outlet 532. Use of a flush gas in this way provides control over the environment of the reactor interior and can be used to provide positive pressure to ensure any leaks from the tubes 104 do not spread process gases into the housing interior.

In other cases, a static oxidizing atmosphere, such as air, oxygen, or oxygen-enriched air, can be provided around the tubes within the enclosure. Such gases can be flowed through the housing structure 502, as described above, to provide a consuming atmosphere in the event of a tube leak. In such cases, any gas that leaks from one of the tubes 104 into the enclosure of the heating structure 504 would instantly combust. The heating structure 504 can be configured to contain the release of energy such combustion would bring and to vent the gas products of such combustion out of the enclosure, for example through the gas outlet 532.

FIG. 5B is an exploded view of the reactor 500. The heating structure members 508 are moved apart to an open position. The heating structure members 508 of the reactor 500 can thus be made movable in the ways shown in FIGS. 4A-4C, and according to other embodiments herein, to allow access to the tubes 104 and the structures along the heating sides 506 of the heating structure members 508. Like other reactors described herein, the reactor 500 has radiant covers 518 to provide closure of the reactor 500 at top and bottom thereof during operation when the heating structure members 508 are engaged to enclose the tubes 104. Here, only the radiant top cover 518 is visible.

A terminal member 520 is disposed along each end portion 510 of each heating structure member 508A and 508B to provide electrical current to the heating elements 504 of the heating structure member 508A and 508B. A first terminal member 520A is disposed at one end portion 510, along an exterior surface thereof, and a second terminal member 520B is disposed at the opposite end portion 510, also along an exterior surface thereof. Each heating element 504 can be electrically coupled to the first and second terminal members 520A and 520B to receive and conduct electric current. The heating elements can be disposed through the respective housing members 502A and 502B at the end portions 510 thereof, to connect electrically to the terminal members 520. Each pair of terminal members 520 is connected to the same number of heating elements 504. In the case shown in FIG. 5B, there are two paired terminal members 520 for each heating structure member 508, and all heating elements 504 of the heating structure member 508 are connected to the two opposite terminal members 520. In other cases, terminal members 520 can connect to a subset of the heating elements 504, so there can be more than one pair of terminal members 520, for example two pairs or three pairs. Any suitable number of pairs of terminal members 520, and any suitable configuration of a power structure for the heating members 504, can be used for a heating structure member 508.

The end portions 510 of the heating structure members 508 in this case are curved, but in other cases, as described above, the end portions 510 can be cornered, for example at right angles with the wall portion 514. In this case, the end portions 510 extend continuously from edge to opposite edge of the wall portion 514 in the second direction. In other cases, the end portions 510 might extend only partway from edge to edge in the second direction. Thus, the end portions 510 can, in some cases, be tabs or plates, and more than one such tab or plate could be used for an end portion 510. Where tabs or plates or partial end portions are used, each end portion member can be curved and/or cornered independently in any suitable way. Some tabs or plates can be cornered while others are curved, and different plates or tabs can have different curvature radii. Such methods can be used, for example, where structures of the reactor might need geographic accommodation.

FIG. 5C is a schematic elevation view of a panel of the reactor 500. The panel of the reactor 500 is similar to the panel shown in FIG. 4B, with the exception that the panel of FIG. 5C has curved end portions 510, while the end portions of the panel of FIG. 4B are straight and cornered. Two of the supports 419 are shown for supporting the heating elements 504 in rod-over-bend configuration, as in the panel of FIG. 4B

It should be noted, when determining how many heating elements, such as the heating elements 504 and 409, to use, that these heating elements are ohmic heating components that transform electric current into radiant thermal energy by electrical resistance. Any type of ohmic heating components can be used as the heating elements. In FIGS. 4B and 5C, a conductor is supported by the protrusions 419 extending from the heating side 506 of the heating structure member 508 in the direction of curvature of the end portions 510 and toward the tubes 104. The conductor for one heating element 504 extends generally across the surface of the respective housing member in the first direction, supported by the protrusions 419 in any suitable way. In this case, the conductors are shown in “rod-over-bend” configuration, which is a substantially boustrophedonic pattern, going back and forth along the second direction of the wall portion 514, and proceeding along the first direction of the wall portion 514 from one end portion 510 to the opposite end portion 510. A plurality of such heating elements 504 is used in this case. In other configurations, bar-shaped conductive members can be disposed along the inner surface on the heating side 506 of the wall portion 514, which can be, for example, silicon carbide or other suitable material to radiate energy upon flow of electric current. This heating element structure, also in “rod-over-bend” configuration, is similar to that shown in FIG. 4B.

As resistive elements, the conductors shown here result in conversion of electrical energy in the electric circuit to radiant thermal energy. Thus, driving voltage for the circuit must be balanced with the resistive mass of the conductors in deciding how many conductors to use and how they are to be arranged. Driving voltage for such circuits can be selected, and characteristics of the conductors and number of heating elements to provide a desired energy output and uniformity across the panel. Thus, for example, the circuits can be driven using 120 V, 240 V, 480 V, 1,200 V, 2,400 V, 4,160 V, or any suitable voltage. Amperage of the circuit can be calculated based on the driving power needed to emit the requisite energy for a given process. For example, where 480 V power is used, 18,000 A provides 15 MW of power. Conductance area can be computed based on resistivity of the material used and resistance needed to power a desired radiant thermal emission. Thus, for example, where 15 MW of 480 V power is used, a total conductive area of 47.6 in² will yield a suitable radiant output for some cases. At the other extreme, where 15 MW of 4,160 V power is used, current of 2,082 A and conductive area of 1.4 in² will provide a suitable radiant output for some cases.

In some cases, for example where high amplitude AC power is used to power the heating elements 504, it can be advantageous to power all the heating elements 504 of a heating structure member 508 using single-phase power to avoid developing high potential differences over short distances, which can lead to unwanted effects such as arcing. In such cases, all the heating elements 504 of one heating structure member 508 may be arranged in series or parallel configuration in a single electrical circuit. Resistance in the circuit can be managed by material selection and conductor configuration such that thermal emission along the circuit is substantially uniform. In other cases where high heat flux is desired, using high voltage power, such as 4 kV power (or 4,160 V power) can simplify power delivery to heating elements such as the heating elements 504. In cases where high heat flux is to be generated using electric power, smaller wiring can be used for emitters and other electrical conduits, and can be arranged more closely in a smaller volume, when using high voltage.

The structure of the reactor 500, which can be a “clamshell” structure in some cases, can be used to provide movement of the heating structure members 508, as shown in the other embodiments described herein, such that the tubes 104, and potentially other structures that would be inside the enclosure of the housing members 502A and 502B during operation, can be accessed. The two heating structure members 508A and 508B of a heating structure 512 can be moved apart to provide such access. The heating structure members 508 of the reactor 500 can be attached to any of the support members described herein so that the heating structure members 508 can be movable with respect to the tubes 104 to provide access to the tubes 104 and structures of the heating members 508 that face the tubes 104.

Referring again to FIG. 5B, each reactor 502 has closure members 530, which engage to form the closure structure 522 shown in FIG. 5A. The closure members 530 can engage to securely fasten the heating structure members 508A and 508B together to form the heating structure 508 with an enclosure 533 defined by the heating sides 506 of the heating structure members 508A and 508B. The closure members 530 are a first closure member 530A, attached to the first heating structure member 508A, and a second closure member 530B, attached to the second heating structure member 508B. Each of the first and second closure members 530A and 530B mis located at the end portion 510 of the respective heating structure member 508A and 508B at a location suitable for operation of such closure members 530. For example, if the closure members 530 are to be operated manually, the closure members 530 will be located at a location suitable for access.

The heating structure members 508 of the reactor 500 can be configured, as shown in FIGS. 4A-4D, to move along rails between the closed and open positions shown in FIGS. 5A and 5B, with arrangement of the supports, rails, terminal members 520 and the like as described in connection with those figures.

The reactor 500 depicted in FIGS. 5A-5C has heat emitters 504 that are arranged along a single plane. In some cases, it can be advantageous to arrange heat emitters 504 along a plurality of parallel planes. FIG. 5D is an isometric view of a heating member structure 550 according to one embodiment. The heating member structure 550 can be used in any of the reactors described herein. Multiple heating member structures 550 can be used in a single reactor. The heating member structure 550 is designed to be used in pairs, with the interior of two of the heating member structure 550 facing each other. The heating member structure 550 has a housing member 552, which is like the other housing members described herein. The housing member 552 has a flat inner surface 554, much like the other housing members described herein, that supports a plurality of heating elements 556 in a manner facing away from the inner surface 554 and towards tubes carrying catalyst to be heated to perform the endothermic reactions described herein. The housing member 552 has opposite end portions 558 that extend in an inward direction away from the inner surface 554 so that the end portions 558 of two heating member structures 550 can engage and abut to enclose the tubes 104 between two heating member structures 550.

The heating elements 556 of the heating member structure 550 are arranged in a plurality of parallel planes. In this case, a first plurality 560A of heating elements 556 is arranged along a first plane, a second plurality 560B of heating elements 556 is arranged along a second plane substantially parallel with the first plane, and a third plurality 560C of heating elements 556 is arranged along a third plane substantially parallel with the first plane and the second plane. The first, second, and third plurality of heating elements 560A, 560B, and 560C are arranged, in this case, in an overlapping relationship, such that, for example, a portion of the second plurality 560B of heating elements is between the first portion 560A and the third portion 560C. A first portion 562A of the flat inner surface 554 of the housing member 552 is covered by all of the first, second, and third plurality 560A, 560B, and 560C, of heating elements 556. Two second portions 562B of the flat inner surface 554 are covered by only two of the first, second, and third plurality 560A, 560B, and 560C of heating elements 556. Two third portions 562C of the flat inner surface 554 are covered by only the first plurality 560A or the third plurality 560C of heating elements 556. The heating elements 556 of the heating member structure 550 thus form an overlapping layered heating structure 564 for heating the tubes filled with catalyst.

The overlapping layered heating structure of the heating structure member 550 concentrates heat emitters into a smaller radiant area to increase thermal flux without having to increase the size of the radiant emitters. Since the number of emitters is effectively multiplied using a three-dimensional volume, each emitter can be smaller than emitters that would be needed to deliver the same thermal flux arranged in a single plane. Such arrangements can reduce the overall footprint of the reactor and increase the heating efficiency of the reactor by concentrating thermal emission into a smaller flux area. The emitters depicted here can all be powered using single-phase power to reduce the complexities of varying voltages among the emitters, and the degree of overlap of the heating planes can be varied according to the needs of any process to increase or decrease thermal flux and radiant area of the heating structure.

It should be noted that multiple heating structure members 550 can be assembled into a heating wall, to be used with an opposite and matching heating wall, for heating tubes filled with catalyst. The tubes would typically be arranged in a manner extending substantially parallel to the longitudinal portion of the emitters of the heating structure members 550. Using multiple units such as the heating structure member 550 allows for independent control of each heating structure member 550, which in turn allows for spatial and/or spatio-temporal control of thermal flux into the reactor tubes to control the reactions happening within the tubes.

In general, where a thermal reactor such as those described herein has heating structures capable of delivering a thermal flux that varies according to location, the reactor can be configured to deliver a heating rate that varies with longitudinal or axial location. Thus, in the reactors herein, where reaction tubes containing catalyst are arranged in substantially parallel orientation, with the longitudinal axes of the individual tubes defining a longitudinal axis of the reactor that extends from the inlet of the tubes or the inlet of the reactor to the outlet of the tubes or the outlet of the reactor, the reactor can be configured to provide a heating rate that varies from the inlet to the outlet. For example, the reactor can be configured to provide a heating rate that declines from the inlet to the outlet or increases from the inlet to the outlet. If desired, the reactor can be configured to provide a heating rate that increases in some locations along the reactor axis and decreases in other locations along the reactor axis, or that is substantially constant along the axis from the inlet to the outlet, or any combination thereof. For example, the reactor could be configured to provide a heating rate that increases from the inlet to a first intermediate point along the axis of the reactor, is constant from the first intermediate point to a second intermediate point along the axis of the reactor, and decreases from the second intermediate point of the reactor to the outlet. With the sensors and control structures described herein, a target heating rate profile can be provided to a controller, which can control power delivery to heating elements to control the heating rate profile of the reactor to the target profile. If desired, using such controls and sensors, the heating rate profile can be changed at will merely by providing a new target heating rate profile to the controller. It should be noted that such heating rate profiles could be linear, as a function of the reactor axis, curved, segmented, periodic, or any desired pattern.

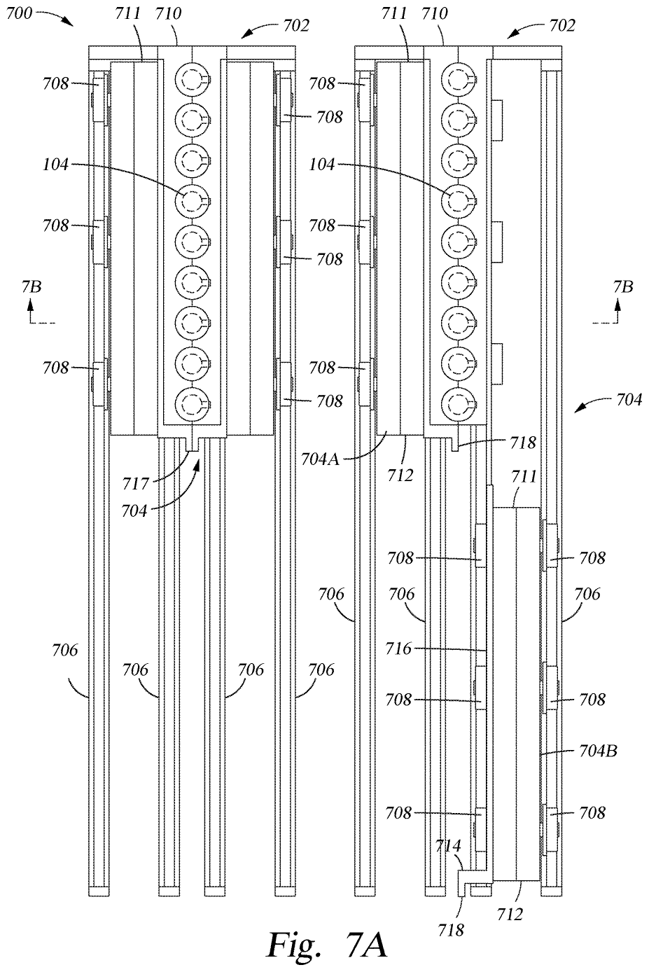

FIG. 6 is a schematic side view of a reactor facility 600 comprising a plurality of reactors 602 according to another embodiment. The reactor facility 600 is similar to the reactor facilities of other embodiments shown herein, with movable heating structures that move towards the tubes 104 to engage with the tubes 104 and provide radiant thermal energy from electric power for an endothermic reaction to be performed within the tubes 104. In the reactor facility 600, the heating structures are movable in a curved or arcuate motion away from the tubes 104 to an open position for maintenance and/or repairs, and back to a closed position for operation.

Here, heating structure members 604 of the reactor facility 600 are shown here schematically, without the detail of heating elements and other components, to simplify the figure. Each heating structure member 604 is attached to a swivel mount 606, which in turn is attached to a support member 608, which can be like a post or wall as above. In this case, the support member 608 is not movable, but the support member 608 could be made movable for any suitable purpose. In this case, the swivel mount 606 comprises a plurality of arms 610, each arm 610 rotatably attached to the heating structure member 604, at a surface opposite from the heating side 605 which faces the tubes 104, such that the heating structure member 604 and the arm 610 can relatively rotate. Each arm 610 is also rotatably attached to the support member 608 such that the arm 610 and the support member 608 can relatively rotate. The arms 610 allow the heating structure member 604 to move, in a curved motion guided by the arms 610, to swivel or swing away from the tubes 104 to a retracted position located near the support member 608, and to move in a similarly curved motion guided by the arms 610 toward the tubes 104 to an extended position of engagement with the tubes 104 for operation.

An actuator 612 can be coupled between the support member 608 and the heating structure member 604 to drive motion of the heating structure member 604. In this case, a hydraulic actuator is shown, but any suitable actuator 612 can be used. The hydraulic actuator here is rotatably attached both to the heating structure member 604 and to the support member 608. The hydraulic actuator 612 extends to move the heating structure member 604 away from the support member 608 and toward the tubes 104 in a curved motion guided by the arms 610 to an extended position adjacent to, or in contact with, the tube plates 422, to engage with the tubes 104 and form the enclosure of the heating structure for operation. The hydraulic actuator 612 retracts to move the heating structure member 604 away from the tubes 104 and toward the support member 608 in a similar curved motion guided by the arms 610 to a retracted position that provides access to the tubes 104 and the parts of the heating structure members 604 facing the tubes 104.

It should be noted, of course, that the heating structure members 604 described herein can be positioned at any desired location between the extended, engagement, closed, operating position and the fully retracted, open, maintenance, idle position. Here, two arms 610 and one actuator 612 are shown connected between the support member 608 and the respective heating structure member 604. One support member 608 also supports two swivel mounts 606, one for each adjacent reactor 602 A swivel support as described herein can be configured in any suitable way. For example, one support member 608 can be used for each swivel mount 606. Additionally, more arms 610 can be used, any suitable number if needed to support the weight of a heating structure member 604. Also, more or different actuators can be used to move the heating structure members 604. For example, two or more hydraulic cylinders can be used if the size or weight of a heating structure member 604 warrants. Additionally, the actuator (or actuators) 612 can be supported from the ground, floor, or a base, rather than at the support member 608. Other suitable configurations can be used.

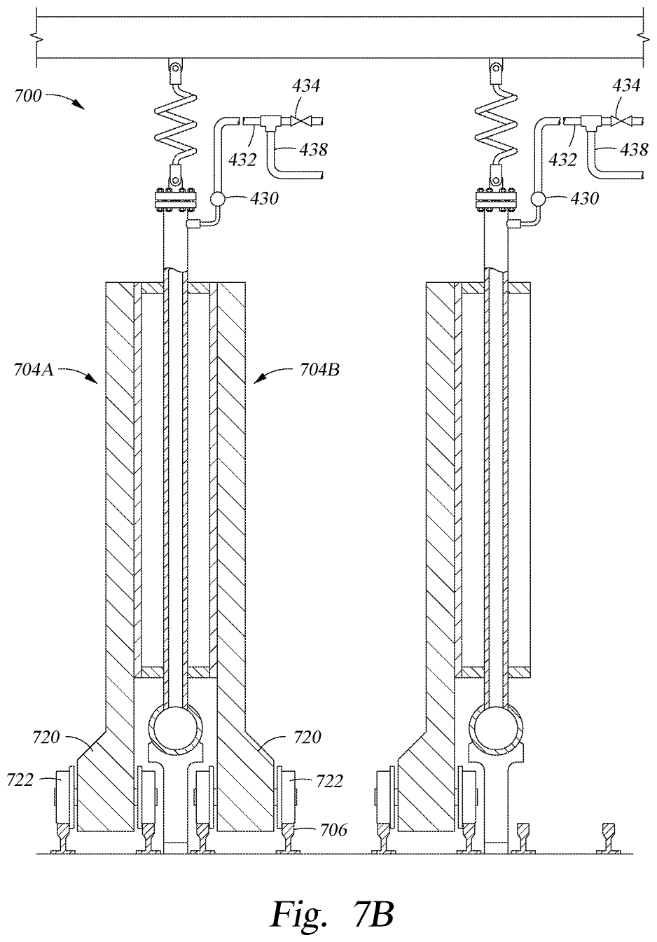

FIG. 7A is a schematic top view of a reactor facility 700 according to another embodiment. The reactor facility 700 has reactors 702, two of which are shown here (any suitable number can be used in a reactor facility). As with the other reactors herein, each of the reactors 702 has a plurality of tubes 104 for holding catalyst to perform an endothermic reaction, along with a heating structure 704 to provide electric radiant thermal energy to the reaction within the tubes 104. Each of the heating structures 704 has a first heating structure member 704A and a second heating structure member 704B for positioning on opposite sides of the tubes 104, each having heating elements (not shown) as in the other embodiments herein.

The heating structure members 704A and 704B of each reactor 702 are, in this case, movably disposed on rails 706 and supported by rollers 708. The rails 706 extend in a lateral direction substantially parallel to the first direction of each of the heating structure members 704A and 704B. Thus, whereas the rails 420 of FIGS. 4A-4C extend in a direction substantially perpendicular to both the first and second directions of the heating structure members 406A and 406B, here the rails 706 extend laterally so that the heating structure members 704A and 704B of each reactor 702 can be moved laterally in the first direction to a position that allows access to the tubes 104 and to structures of the heating structure member 704A and 704B that face the tubes 104. The heating structure member 704B is shown, here, moved to the access position.

Each reactor 702, in this case, has an end wall 710 that provides a stop for the heating structure members 704A and 704B at a distal end 711 thereof and helps define the enclosure of the reactor 702 at the distal end 711 of the heating structure members 704A and 704B. At a proximate end 712 of each heating structure members 704A and 704B is an end portion 714 that extends from a heating surface 716 of each heating structure member 704 toward the tubes 104, so that the end portion 714 of the heating structure member 704A engages with the end portion 714 of the heating structure member 704B to help define the enclosure of the reactor 702, when both heating structure members 704A and 704B are in a closed operating position.

Each reactor 702 has a closure 717, comprising two closure members 718, one closure member 718 attached to each of the heating structure members 704A and 704B to engage together when the heating structure members 704A and 704B are in the closed operating position. Here, the closure members 718 are each located at an end of the respective end portion 714 so that the two closure members 718 engage, or can be engaged, at substantially the same time the end portions 714 of the heating structure members 704A and 704B engage and/or abut. As the heating structure members 704A and 704B can be moved independently in this case, when one or both heating structure members 704A and 704B are to be moved, the closure members 718 can be disengaged so that the heating structure members 704A and 704B can be moved. As noted before, in the top views of the various reactors herein, only one closure is visible. Thus, in the view of FIG. 7A, only one closure 717 is visible, but more than one closure can be used.

FIG. 7B is a schematic cross-sectional view of the reactor facility 700. In this cross-sectional view, the proximate ends of the heating structure members 704A and 704B, with the closure members 718 thereof, are not visible. As in the embodiments of FIGS. 4A-4C, each heating structure member 704A and 704B is supported by a movable base 720 which has rollers 722 to engage with the rails 706 to provide movement of the heating structure members 704A and 704B. In this case, the rollers 722 are mounted to each respective base 720 in an orientation along the first direction to engage with the rails 706 similarly so oriented. As noted above, the heating structure members 704A and 704B are independently supported by a movable base 720, so as in the embodiments of FIGS. 4A-4C, each heating structure member 704A and 704B can be moved independently of the other, as shown in FIGS. 7A and 7B.

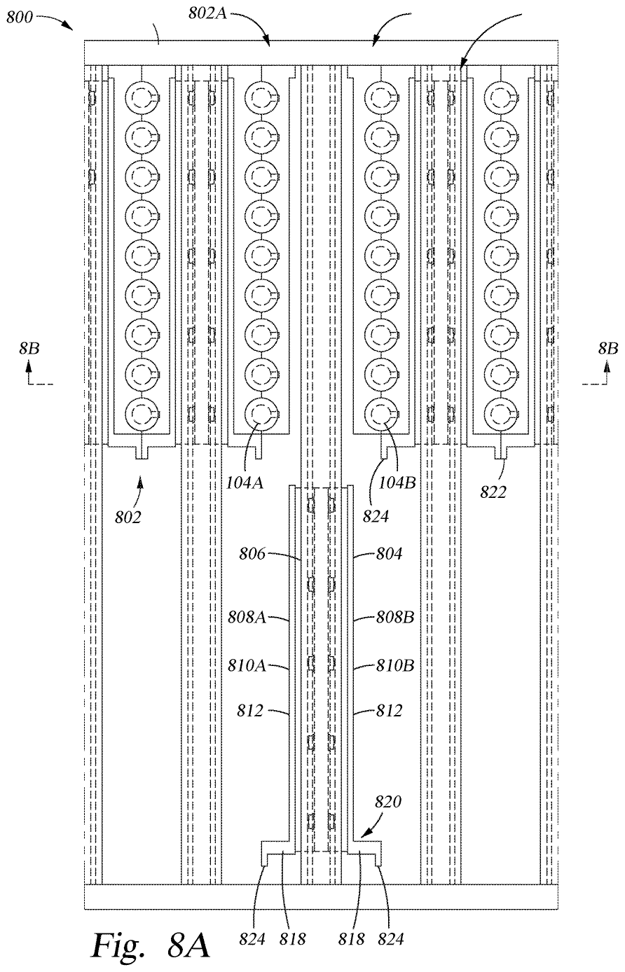

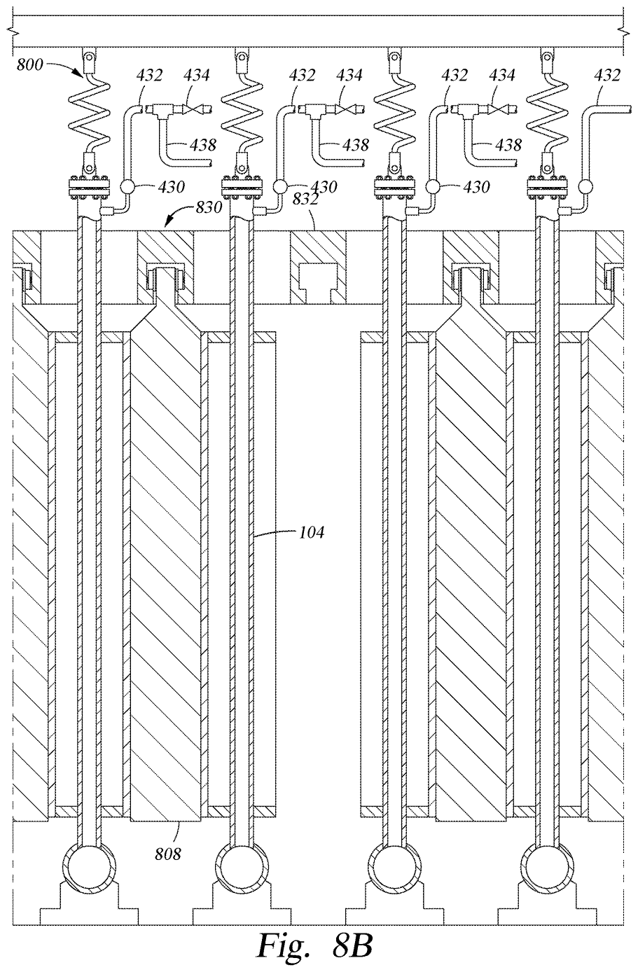

FIG. 8A is a schematic top view of a reactor facility 800 according to another embodiment. Four reactors 802 of the reaction facility 800 are shown in FIG. 8A. The facility 800 of FIG. 8A is similar to the facility 700 of FIGS. 7A and 7B, where the heating structure members slide out laterally to provide access, but in this case, only one heating structure 804 provides electric radiant thermal energy to two adjacent reactors 802. The heating structure 804 has a support member 806 to support two heating element structures 808 (shown schematically to simplify the figure), like the heating elements structures described elsewhere herein, on opposite sides of the support member 806. The support member 806 is disposed between the tubes 104 of two adjacent reactors 802, with two heating sides 810 on opposite sides facing the two adjacent groups of tubes 104. Thus, each heating structure 804 has two heating sides 810, opposite one another and facing the tubes 104 of two adjacent reactors 802. The heating structure 804 has a first heating element structure 808A coupled to a first heating side 810A facing a first group of tubes 104A of a first reactor 802A. The heating structure 804 also has a second heating element structure 808B coupled to a second heating side 810B facing a second group of tubes 104B of a second adjacent reactor 802B. Thus, a single heating structure 804 provides electric radiant thermal energy to two adjacent reactors 802. The reactor facility 800 has multiple such heating structures 804 to heat all the tubes 104 of all the reactors 802.

The heating structures 804 are configured to move laterally, in the first direction, as with the heating structure members 704A and 704B of the facility 700, but the two heating element structures 808A and 808B are not independently movable, since they are attached to the same support member 806 of one heating structure 804. In this case, each heating structure 804 is configured to move laterally along rails 812, similar to the rails 706 of the facility 700, extending laterally beyond the reactors 802 to allow the heating structures 804 to be moved aside, thus providing access to the tubes 104 and the components of the heating structures 808 facing the tubes 104.

Similar to the facility 700, the facility 800 has an end wall 814 to provide a stop for the heating structures 808 at a distal end 816 thereof, and end portions 818 at a proximate end 820 thereof. In this case, the end portions 818, extending toward the respective adjacent groups of tubes 104A and 104B, and thus extending away, one from the other, engage with the end portions 818 of an adjacent heating structure 808 when both adjacent heating structures 808 are in the closed, engaged, operational position. Each heating structure 808 is independently movable, and when one heating structure 808 of the facility 800 is removed by moving laterally along the rails 812, two adjacent reactors 802 are idled, using procedures described above for idling the reactors. As with the facility 700, the heating structures 808 of the facility 800 have closures 822, which comprise one closure member 824 coupled to each adjacent end portion 818 of two adjacent heating structures 808. When the adjacent heating structures 808 are in the closed operational position, the closure members 824 of the adjacent end portions 818 of the adjacent heating structures 808 can be engaged to provide closure of a reactor 802.

It should be noted that, instead of rolling on rails beneath the reactors, as in the embodiments of FIGS. 4A-4C and 7A-7C, the heating structures and heating structure members described herein can be suspended from overhead supports in a movable way. For example, rails can be attached to overhead support structures and rolling supports can be coupled to the overhead rails to suspend the heating structures and heating structure members. All the reactors with movable heating structures can use rails and rollers coupled to support bases underneath the heating structures, rails and rollers coupled to overhead supports above the heating structures, or a combination of both. FIG. 8B is a schematic side view of the reactor facility 800 of FIG. 8A. showing an overhead support arrangement. Here, each of the heating structures 808 is supported by a rolling support 830 at an upper extremity of the support member 806. The rolling support 830 is coupled to overhead rails 832, in this case internal roller rails, that extend laterally in the first direction beyond the extend of the reactors (i.e. the tubes 104) so that the heating structures 808 can be moved to allow access to the tubes 104 and the components facing the tubes 104.

The movable heating structures and heating structure members herein can be actuated by any suitable method. Hydraulic actuators can be used, or motors can be coupled to the rolling supports to provide movement. Thus, in one case, the rolling supports can be cog rail systems with cogs attached to the support bases of the heating structures and disposed to engage with rails having teeth. Motors can be coupled to rotate the cogs such that the heating structures move with rotation of the cogs against the teeth of the rails. Other suitable movement methods can also be used.

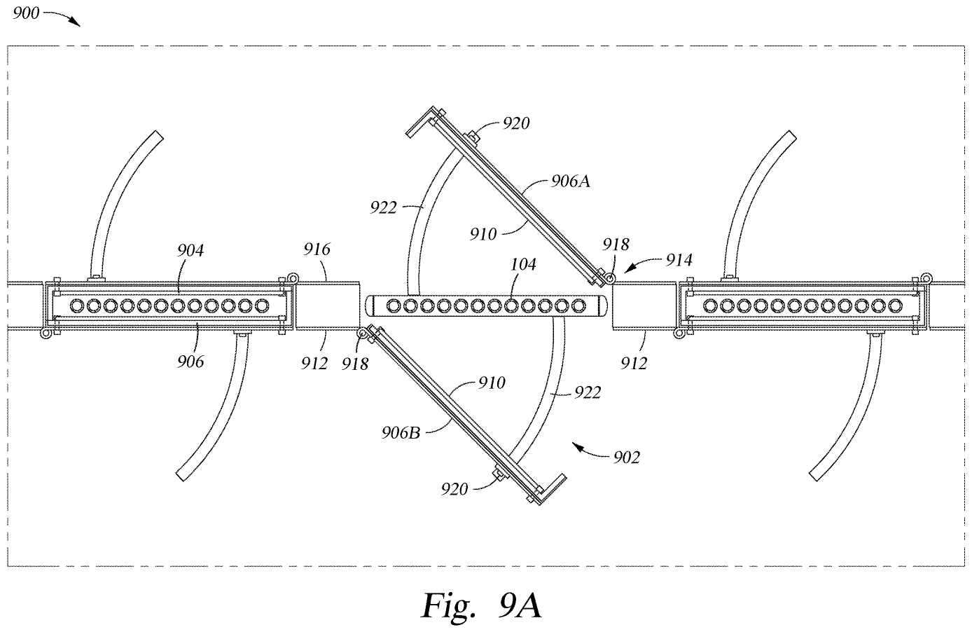

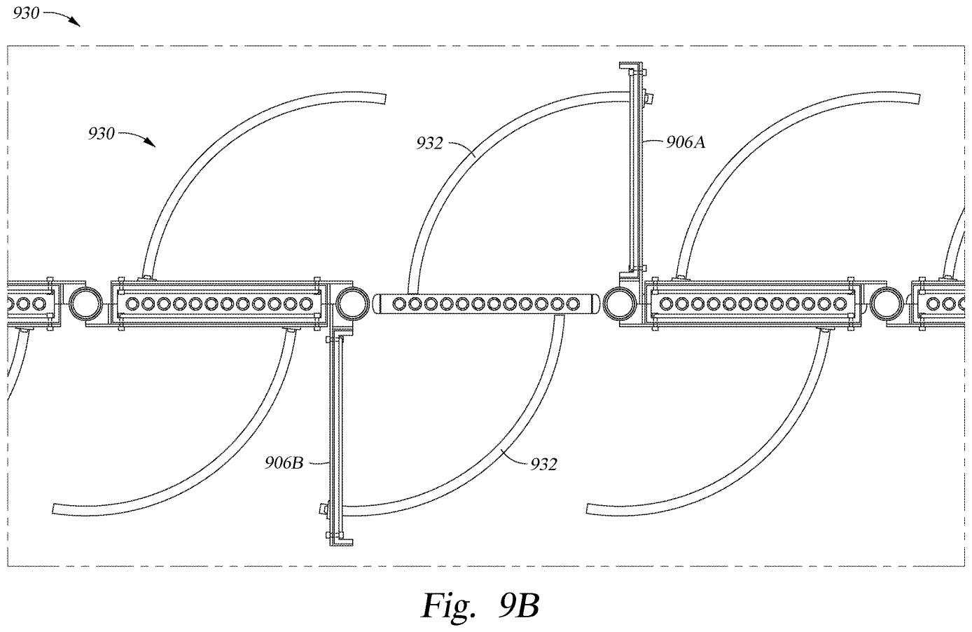

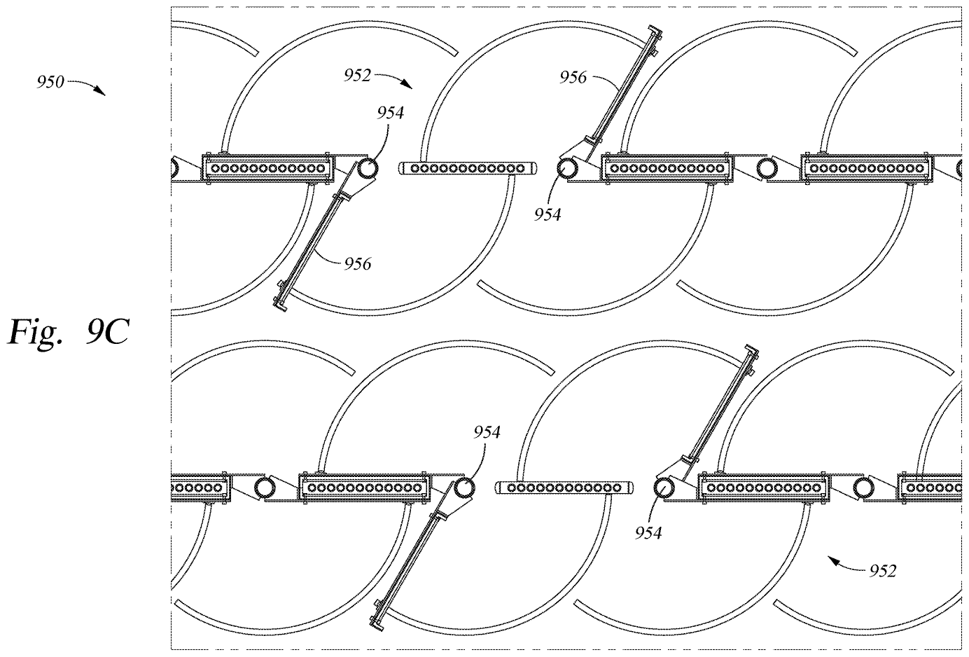

In another embodiment, the heating structure of a reactor can have heating structure members that are mounted on hinges to allow rotary movement of the heating structure members about the hinges to open and close the reactor. FIG. 9A is a schematic top view of a reaction facility 900 according to one embodiment. The facility 900 has a plurality of reactors 902, three of which are fully visible here. As with the other embodiments herein, each reactor 902 has a plurality of tubes 104 containing catalyst arranged in a parallel and coplanar arrangement, and a heating structure 904 that encloses the tubes 104 during operation and provides radiant thermal energy to the tubes 104. The heating structure 904 comprises two heating structure members 906, a first heating structure member 906A and a second heating structure member 906B, which are disposed on opposite sides of the tubes 104 with a heating side 910 of each heating structure member 906 facing the tubes 104 to provide radiant thermal energy from heating elements (not shown to simplify the figure) coupled to the heating side 910 of the heating structure members 906. As before, the heating elements are electrically connected to terminal members 912, in this case located along the opposite edges 914 of the heating structure members 806.

In this case, an edge 914 of each heating structure member 906 is mounted to a support 916 by one or more hinges 918 (one hinge is visible in this view for each heating structure member). In this case, the supports 916 also serve to house or support the terminal members 912. Each heating structure member 906A and 906B is thus able to rotate at the hinge 918 to an open position, with the edge 914 opposite from the hinge 918 being spaced apart from the tubes 104, to allow access to the tubes 104 and the heating side 910 of the heating structure member 906.

To support the weight of the heating structure member 906 and reduce strain on the hinge 918, each heating structure member 906 may have a roller 920 coupled to the heating structure member 906 at a bottom, or lower portion, thereof to engage with a circular rail 922, allowing the roller 920 to roll along the rail 922 in a circular direction, about an axis perpendicular to the drawing plane, as the heating structure member 906 rotates about the hinge 918. Thus, to open one of the reactors 902, one or both of the heating structure members 906A and 906B of the reactor 902 are rotated outward on the hinge 918, such that the distal edge 914 of the heating structure member 906 is spaced away from the tubes 104. To close the reactor 902, the heating structure members 906 are rotated inward on the hinge 918 to engage together adjacent to the tubes 104. Here, the two hinges 918 (or groups of hinges, as necessary) supporting the two heating structure members 906 are located at opposite edges 914 of the heating structure members 906 such that the first heating structure member 906A rotates in a first circular direction and the second heating structure member 906B rotates in a second circular direction, the two heating structure members 906 rotating substantially away, one from the other, to open the reactor 902 and rotating substantially toward one another to close the reactor 902. In another case, the two hinges 918 can be located at the same edge 914 of the two heating structure members 906 so that the heating structure members 906 rotate the same way, albeit in opposite directions with respect to the tubes 104. The extent of the circular rails 922 determines the extent to which the heating structure members 906 can rotate away from the tubes 104.

Each of the heating structure members 906 has an end extension 917 that extends from an edge 914 of the heating structure member 906 opposite from the hinge 918 that couples the heating structure member 906 to the support 916. The end extension 917 is sized to couple to the opposite heating structure member 906, when the heating structure members 906 are in the closed position. Thus, the extension 917 of one heating structure member 906 extends to contact the opposite heating structure member 906 when the two heating structure members are in the closed position.

FIG. 9B is a schematic top view of a reaction facility 930 according to another embodiment. The reaction facility 930 is similar to the reaction facility 900, with the exception that the reaction facility has circular rails 932 with larger angular extent than the circular rails 922 of FIG. 9A. The circular rails 932 enable the heating structure members 906A and 906B of the facility 930 to rotate to an extent that is farther than for the facility 900, providing increased access to the interior structures of the reactors of the facility 903. Thus, whereas the rails 922 of FIG. 9A have an angular extent of about 45°, the rails 932 of FIG. 9B have an angular extent of about 90°, showing that any angular extent can be used for such reactor systems.

The rotation of the heating structure members 906 of the facilities 900 and 930 can be achieved using any suitable means. For example, the roller 920 can be motorized, or as in other embodiments herein a hydraulic actuator can be provided to open and close the heating structure members. Any suitable means for actuating the rotation can be used. Additionally, as in the embodiment of FIG. 8B, the rail supports can be overhead, with the heating structure member hanging from the overhead rail by a roller.

FIG. 9C is a schematic top view of a reaction facility 950, according to another embodiment. The reaction facility 950 illustrates an arrangement of reactor trains 952 with reactors having circular rails 962 with angular extent that is over 90°, in this case about 120°. Each of the reactors trains 952 has a plurality of reactors 954 of the type shown in FIGS. 9A and 9B, with the reactors of each train 952 spaced to accommodate opening the heating structure members thereof to the full angular extent of the rails 962. The reactor trains 952 are arranged and positioned with the reactors 954 in parallel staggered arrangement, with the two trains shown spaced apart to allow full rotation of the heating structure members of each reactor 954 without interference from any other structures. The reactors 954 of the trains are positioned to allow heating structure members 956 of the reactors 954 to open, where the open position of two heating structure members 956 from the trans 952A and 952B are close but do not interfere.

Thus, a number of different electrical radiant heating structures, some movable to allow easy maintenance, can be used to heat tubes, or other suitable vessels, containing catalyst to perform an endothermic gas-phase reaction. Such structures can provide uniform heating of catalyst-filled tubes, for example, to high temperatures to support endothermic reactions requiring extreme temperatures, such as hydrocarbon reforming reactions.

The reactors described herein, which have multiple electrical radiant heating elements that can be powered independently, can be used to control thermal flux applied to reaction tubes filled with catalyst. Using methods described herein, thermal flux of any of the reactors described herein can be controlled in substantially independent zones, such that a first zone of the reactor has a first spatial and/or temporal thermal flux profile and a second zone of the reactor has a second spatial and/or temporal thermal flux profile, substantially independent from the first profile. Thus, the first and second profiles can each, independently, be constant or can vary in spatial dimensions, for example axial and radial dimension, and or in time. Where tubes are arranged along a plane and surrounded on two opposite sides by thermal emitters, as in the reactor 500 and other like reactors, the methods described herein can be used to control thermal flux in the axial direction of the tubes, in the lateral direction of the tubes, in the radial dimension of the tubes (i.e. within the interior of the tubes), and in time.

By varying aspects of the heating elements, the thermal flux can be adapted to a desired spatial and/or temporal profile. In one aspect, power input to the heating elements can be controlled and varied to yield any desired thermal flux profile. In another aspect, heating properties of heating elements, arising from composition of the heating elements and/or thermal controls along or near the heating elements, can be varied to yield a desired thermal flux profile. For example, the composition of heating elements can be varied to result in varying thermal output of a heating element along its length. Thus, where a heating element as shown in FIG. 5C is used, which is a continuous electrical conductor that emits ohmic thermal energy, a first portion of the heating element can have a first composition that provides a first thermal emission profile or spectrum, a second portion of the heating element, integrally connected with the first portion, can have a second composition that provides a second thermal emission profile or spectrum. The second composition can be made different from the first composition by chemically treating only the second portion of the heating element, for example by heating the second portion in the presence of a material (e.g. gas, liquid, or both) to be incorporated into the second portion to change the composition thereof. The second composition of the second portion can be realized as a coating that increases or reduces electrical resistivity and/or thermal emissivity of the second portion, relative to the first portion.

In other aspects, arrangement of heating elements can be varied to deliver a desired spatial profile of thermal flux. The heating elements can be arranged with more or less packing density to deliver more or less thermal flux. Thus, a reactor can have a heating structure that has a plurality of heating elements arranged with a varying packing density. A first plurality of heating elements in the heating structure can be arranged with a first packing density, and a second plurality of heating elements in the heating structure can be arranged with a second packing density different from the first packing density. Such a heating structure can accordingly have thermally radiating surfaces that provide a varying density of radiating surface per unit area. Such arrangements can be achieved using heating elements having the same radiating surface area, or different radiating surface area. Thus, a heating structure can have a first plurality of heating elements, each having a first radiating surface area, and a second plurality of heating elements, each having a second radiating surface area different from the first radiating surface area. Such heating structures can be operated to provide different thermal flux in the areas having different packing density, or radiating density, of heating elements.

Wires carrying power to heating elements can also be thicker or thinner to carry more or less current to heating elements, thus providing a desired thermal flux profile. A first plurality of heating elements in a heating structure can be powered using a first plurality of wires having a first thickness and a second plurality of heating elements in the heating structure can be powered using a second plurality of wires having a second thickness different from the first thickness. Using such wiring, the first plurality of heating elements can receive maximum current that is different from the maximum current that can be received by the second plurality of heating elements, resulting in an ability to generate different thermal flux using the different heating elements.

Different materials can also be used for different heating elements to provide different amounts of thermal emission. Thus, a first plurality of heating elements in a heating structure can have a first emissivity and a second plurality of heating elements in the heating structure can have a second emissivity different from the first emissivity. Using such methods of providing different heating elements having different thermal emission characteristics can enable providing a thermal flux profile according to a desired pattern or variation.

It should be noted that all the methods described above, varying packing density, wiring, and composition of heating elements, can be combined in an arrangement of heating elements in a heating structure to provide any desired pattern of thermal flux. In particular, if desired, the methods above can be used in any combination in a heating structure that provides a high thermal flux near an inlet of the tubes 104 holding catalyst and a lower thermal flux near an outlet of the tubes 104. The heating structure can be configured to provide a thermal flux that varies continuously along at least a portion of the length of the tubes 104, for example in a linear profile or sigmoidal profile, or the thermal flux can vary in stepwise fashion at desired locations along the tubes. Thus, a heating structure can be configured to provide a first thermal flux profile in a first area along the length of the tubes 104 and a second thermal flux profile in a second area, different from the first area, along the length of the tubes 104. Using the methods described above, the heating structure can be configured such that the first and second thermal flux profiles are, independently, constant or varying in any desired way. For example, the first thermal flux profile can be constant or can vary spatially and the second thermal flux profile can independently be constant or can vary spatially. The spatial variation can be linear or non-linear in any aspect, and the first and second areas can be spaced apart, adjacent, or overlapping to any degree. For example, overlapping thermal flux profiles can be provided in a heating structure by using heating structures like that shown in FIG. 5D.

In other aspects, shielding members can be used to shade, interrupt, or otherwise reduce thermal flux from the heating elements that is incident upon the reaction tubes. Thus, in a first portion, irradiation of the tubes by the heating elements can be unshaded or uninterrupted, while in a second portion, a shade member, which can be a plurality of wires, a mesh, or an infrared translucent film or material, can shade the second portion such that incidence of thermal radiation on the tubes is reduced relative to the first portion. Combinations of the methods described above can be used to control a thermal flux profile applied to the reaction tubes, and to achieve any of the thermal flux profiles described herein.

While the foregoing is directed to embodiments of one or more inventions, other embodiments of such inventions not specifically described in the present disclosure may be devised without departing from the basic scope thereof, which is determined by the claims that follow.

1. A syngas manufacturing reactor, comprising:
a plurality of tubes in parallel arrangement, each tube containing a catalyst; and
an electrical radiant heating structure arranged in proximity with the plurality of tubes, wherein the electrical radiant heating structure extends along a longitudinal direction of the plurality of tubes, transverse to the longitudinal direction of the plurality of tubes, or both.

2. The reactor of claim 1, wherein the electrical radiant heating structure comprises a first heating structure member and a second heating structure member, wherein the first and second heating structure members are movable to enclose the plurality of tubes.

3. The reactor of claim 2, wherein each of the tubes contains a catalyst in a catalyst containing portion of each respective tube, and the first heating structure member and the second heating structure member fit together to enclose the catalyst containing portion of each tube.

4. The reactor of claim 1, wherein the electrical radiant heating structure comprises a first heating structure member and a second heating structure member, each of the first and the second heating structure members comprises a plurality of radiant emitters disposed along an inner surface of a wall portion, and the inner surfaces of the first and the second heating structure members face each other.

5. (canceled)

6. The reactor of claim 2, wherein each of the first and the second heating structure members emit radiant energy toward the tubes in operation, and each of the first and the second heating structure members is mounted on a movable support to provide movement of the first and the second heating structure members.

7. The reactor of claim 1, wherein the electrical radiant heating structure is configured, or configurable, to input heat into the plurality of tubes at a heating rate that varies in the longitudinal direction.

8. The reactor of claim 7, wherein the heating rate declines between an inlet of the plurality of tubes and an outlet of the plurality of tubes.

9. The reactor of claim 7, wherein the heating rate increases between an inlet of the plurality of tubes and an outlet of the plurality of tubes.

10. (canceled)

11. (canceled)

12. The reactor of claim 1, wherein the electrical radiant heating structure comprises a plurality of electrical radiant heating elements that extend along a lateral direction of the tubes and are distributed along the longitudinal direction of the tubes.

13. The reactor of claim 1, wherein the electrical radiant heating structure has a plurality of heating elements arranged in an overlapping layered structure.

14. A syngas manufacturing reactor, comprising:
a plurality of tubes in parallel arrangement, each tube containing a catalyst in a catalyst containing portion thereof; and
an electrical radiant heating structure arranged in proximity with the plurality of tubes, wherein the electrical radiant heating structure extends along a longitudinal direction of the plurality of tubes, transverse to the longitudinal direction of the plurality of tubes, or both, to enclose the catalyst containing portion of each tube, and the electrical radiant heating structure comprises a plurality of movable heating structure members.

15. The reactor of claim 14, wherein the plurality of movable heating structure members comprises a first heating structure member and a second heating structure member, wherein each of the first and second heating structure members comprises a movable support to allow movement of the first and second heating structure members to enclose the plurality of tubes.

16. The reactor of claim 15, further comprising an inlet manifold coupled to each of the tubes, and outlet manifold coupled to each of the tubes, and a supply conduit coupled to the inlet manifold.

17. The reactor of claim 16, wherein the tubes are arranged in a configuration that defines a plane, and the movable heating structure members are movable in a direction substantially perpendicular to the plane.

18. The reactor of claim 16, wherein the tubes are arranged in a configuration that defines a plane, and the movable heating structure members are movable in a direction substantially parallel to the plane.

19. (canceled)

20. The reactor of claim 14, wherein the catalyst has a floral shape and a ratio of surface area to volume that is about 0.8 to about 2.0.

21. (canceled)

22. The reactor of claim 14, wherein the plurality of movable heating structure members comprises a first heating structure member and a second heating structure member, wherein each of the first and second heating structure members comprises a housing member supported by a movable base and a plurality of electrical radiant heating elements coupled to the housing, wherein each electrical radiant heating element extends along a lateral direction of the tubes.

23. A syngas manufacturing reactor, comprising:
a plurality of tubes in parallel arrangement, each tube containing a catalyst in a catalyst containing portion thereof; and
an electrical radiant heating structure arranged in proximity with the plurality of tubes, wherein the electrical radiant heating structure extends along a longitudinal direction of the plurality of tubes, transverse to the longitudinal direction of the plurality of tubes, or both, to enclose the catalyst containing portion of each tube, and the electrical radiant heating structure comprises a plurality of movable heating structure members, each heating structure member having a plurality of terminal members attached to the heating structure member to provide electric power.

24. (canceled)

25. The reactor of claim 23, wherein the heating structure further comprises a closure to isolate an interior of the heating structure.

26. The reactor of claim 23, wherein each heating structure member also has a plurality of electrical radiant heating elements electrically coupled to the terminal members and extending in a lateral direction of the tubes.

27. (canceled)
